(19) United States
(12) Patent Application Publication
(10) Pub. No.: US 2026/0278446 A1
(43) Pub. Date: Sep. 17, 2026

(54) SYSTEMS, METHODS, AND COMPUTER PROGRAM PRODUCTS FOR HYBRID QUANTUM-CLASSICAL CONTROL OF AN ARTIFICIALLY INTELLIGENT ENTITY

(71) Applicant: Nirvanic Consciousness Technologies Inc., Vancouver (CA)

(72) Inventor: Suzanne Gildert, Vancouver (CA)

(21) Appl. No.: 19/466,250

(22) Filed: Jan. 30, 2026

Related U.S. Application Data
(60) Provisional application No. 63/752,179, filed on Jan. 31, 2025.

(51) Int. Cl. G06N 10/60

(52) U.S. Cl. CPC G06N 10/60

(57) ABSTRACT

Systems, methods, and computer program products that achieve hybrid quantum-classical control of an artificially intelligent entity are described. A classical control system runs a classical prediction algorithm that predicts: a) an action to be performed by the artificially intelligent entity, and b) the perception data that is expected when the action is performed. The artificially intelligent entity performs the predicted action. When the actual perception data differs from the predicted perception data beyond an acceptable threshold, the control system makes a call to a quantum processing system to request a new predicted action determined by a quantum prediction algorithm. The quantum-predicted action may be advantageous over the classical predicted action, and may be used to both: i) improve control of the artificially intelligent entity, and ii) update/train the classical prediction algorithm to improve the classical prediction algorithm as well.

### TECHNICAL FIELD

The present systems, methods, and computer program products generally relate to control of an artificially intelligent entity, and particularly relate to hybrid-quantum-classical control of an artificially intelligent entity.

### BACKGROUND

### DESCRIPTION OF THE RELATED ART

In recent years, artificial intelligence (AI) and robotics have gained substantial attention in both academic and industrial domains. Despite significant advances, current AI systems still rely on classical computation, which may limit their ability to emulate certain aspects of human decision-making. Classical AI models typically struggle with understanding and decision-making in situations outside of those seen in the training data, often known as edge-cases.

Classical AI often requires many thousands or millions of training examples of the problem being solved in order for the classical AI to learn a map from perception inputs to appropriate action outputs. Such systems often do not generalize to unfamiliar environments. This is especially important for AI-controlled machines in the physical world where the environment is evolving, dynamic, chaotic, or requires many social interactions, where it is impractical to collect the breadth of training data in advance required to anticipate a suitable response for any future encounter.

Quantum computing is presently being used to try to understand the behavior of physical systems. In an example, U.S. Pat. No. 11,605,015B2 to Anschuetz et al. describes a hybrid quantum-classical computing system for implementing and optimizing quantum Boltzmann machines to prepare and measure a thermal state on these systems. In another example, U.S. Pat. No. 11,599,823B2 to Liu et al. describes a quantum reinforcement learning agent that can facilitate applying a reinforcement learning policy to available actions.

This background information is provided for the purpose of making known information believed by the applicant to be of possible relevance to the present systems, methods, and computer program products. No admission is necessarily intended, nor should be construed, that any of the preceding information constitutes prior art against the present systems, methods, and computer program products.

### BRIEF SUMMARY

A control system for an artificially intelligent entity may be summarized as including: at least one classical processor; a communication interface communicatively coupled to the at least one classical processor and to at least one quantum processing system; and at least one non-transitory processor-readable storage medium communicatively coupled to the at least one classical processor, the at least one non-transitory processor-readable storage medium storing a classical next-step prediction network and processor-executable instructions and/or data that, when executed by the at least one classical processor, cause the control system to: process perception data corresponding to a state of the artificially intelligent entity; while a prediction error is below a threshold, iteratively: determine, by the classical next-step prediction network, a predicted action of the artificially intelligent entity; determine, by the classical next-step prediction network, predicted perception data corresponding to a predicted future state of the artificially intelligent entity; control the artificially intelligent entity to perform the predicted action; process actual perception data corresponding to an actual future state of the artificially intelligent entity; determine the prediction error between the predicted perception data and the actual perception data; when the prediction error exceeds the threshold: transmit, by the communication interface, a request to the at least one quantum processing system to determine, by a quantum next-step prediction algorithm, a quantum-predicted action of the artificially intelligent entity; receive, by the communication interface, the quantum-predicted action; and control the artificially intelligent entity to perform the quantum-predicted action.

The at least one non-transitory processor-readable storage medium may further store an attention module to monitor the prediction error and control communication with the at least one quantum processing system based on the prediction error. The artificially intelligent entity my be selected from a group consisting of: a physical embodiment, a robot, a virtual avatar, and a non-playable character in a virtual environment.

The artificially intelligent entity may include a physical embodiment with a least one sensor. The perception data may include sensor data from the at least one sensor. The control system may be carried on-board the physical embodiment. The control system may be remote from the physical embodiment, and the communication interface may be communicatively coupled to the physical embodiment. The physical embodiment may include at least one actuator, wherein the processor-executable instructions and/or data that, when executed by the at least one classical processor, cause the control system to control the artificially intelligent entity to perform the predicted action, may cause the control system to define and transmit control signals to the at least one actuator. The perception data may include data from at least one sensor coupled to the at least one actuator.

The processor-executable instructions and/or data, when executed by the at least one classical processor, may further cause the control system to: determine, by the classical next-step prediction network, predicted perception data corresponding to a predicted future state of the artificially intelligent entity in which the artificially intelligent entity performs the quantum-predicted action; process actual perception data corresponding to the actual future state of the artificially intelligent entity in which the artificially intelligent entity performs the quantum-predicted action; and update the classical next-step prediction network based on the quantum-predicted action and the actual perception data corresponding to the actual future state of the artificially intelligent entity in which the artificially intelligent entity performs the quantum-predicted action.

The processor-executable instructions and/or data, when executed by the at least one classical processor, may further cause the control system to: when the prediction error exceeds the threshold: determine, by the classical next-step prediction network, predicted perception data corresponding to a predicted future state of the artificially intelligent entity in which the artificially intelligent entity performs the quantum-predicted action; process actual perception data corresponding to the actual future state of the artificially intelligent entity in which the artificially intelligent entity performs the quantum-predicted action; determine the prediction error between the predicted perception data corresponding to the predicted future state of the artificially intelligent entity in which the artificially intelligent entity performs the quantum-predicted action and the actual perception data corresponding to the actual future state of the artificially intelligent entity in which the artificially intelligent entity performs the quantum-predicted action; if the prediction error between the predicted perception data corresponding to the predicted future state of the artificially intelligent entity in which the artificially intelligent entity performs the quantum-predicted action and the actual perception data corresponding to the actual future state of the artificially intelligent entity in which the artificially intelligent entity performs the quantum-predicted action is below the threshold: update the classical next-step prediction network based on the quantum-predicted action and the actual perception data corresponding to the actual future state of the artificially intelligent entity in which the artificially intelligent entity performs the quantum-predicted action; and if the prediction error between the predicted perception data corresponding to the predicted future state of the artificially intelligent entity in which the artificially intelligent entity performs the quantum-predicted action and the actual perception data corresponding to the actual future state of the artificially intelligent entity in which the artificially intelligent entity performs the quantum-predicted action exceeds the threshold: transmit, by the communication interface, a request to the at least one quantum processing system to determine, by the quantum next-step prediction algorithm, an additional quantum-predicted action of the artificially intelligent entity; receive, by the communication interface, the additional quantum-predicted action; and control the artificially intelligent entity to perform the additional quantum-predicted action.

A computer-implemented method to control an artificially intelligent entity may be summarized as including: processing perception data corresponding to a state of the artificially intelligent entity; while a prediction error is below a threshold, iteratively: determining a predicted action of the artificially intelligent entity; determining predicted perception data corresponding to a predicted future state of the artificially intelligent entity; controlling the artificially intelligent entity to perform the predicted action; processing actual perception data corresponding to an actual future state of the artificially intelligent entity; determining the prediction error between the predicted perception data and the actual perception data; when the prediction error exceeds the threshold: transmitting a request to a quantum processing system to determine a quantum-predicted action of the artificially intelligent entity; receiving the quantum-predicted action; and controlling the artificially intelligent entity to perform the quantum-predicted action.

Determining the predicted action of the artificially intelligent entity may include determining, by a classical next-step prediction network, the predicted action of the artificially intelligent entity. Determining predicted perception data corresponding to a predicted future state of the artificially intelligent entity may include determining, by the classical next-step prediction network, predicted perception data corresponding to a predicted future state of the artificially intelligent entity. The computer-implemented method may further include: determining, by the classical next-step prediction network, predicted perception data corresponding to a predicted future state of the artificially intelligent entity in which the artificially intelligent entity performs the quantum-predicted action; processing actual perception data corresponding to the actual future state of the artificially intelligent entity in which the artificially intelligent entity performs the quantum-predicted action; and updating the classical next-step prediction network based on the quantum-predicted action and the actual perception data corresponding to the actual future state of the artificially intelligent entity in which the artificially intelligent entity performs the quantum-predicted action. In addition or in the alternative, the computer-implemented method may further include: when the prediction error exceeds the threshold: determining, by the classical next-step prediction network, predicted perception data corresponding to a predicted future state of the artificially intelligent entity in which the artificially intelligent entity performs the quantum-predicted action; processing actual perception data corresponding to the actual future state of the artificially intelligent entity in which the artificially intelligent entity performs the quantum-predicted action; determining the prediction error between the predicted perception data corresponding to the predicted future state of the artificially intelligent entity in which the artificially intelligent entity performs the quantum-predicted action and the actual perception data corresponding to the actual future state of the artificially intelligent entity in which the artificially intelligent entity performs the quantum-predicted action; when the prediction error between the predicted perception data corresponding to the predicted future state of the artificially intelligent entity in which the artificially intelligent entity performs the quantum-predicted action and the actual perception data corresponding to the actual future state of the artificially intelligent entity in which the artificially intelligent entity performs the quantum-predicted action is below the threshold: updating the classical next-step prediction network based on the quantum-predicted action and the actual perception data corresponding to the actual future state of the artificially intelligent entity in which the artificially intelligent entity performs the quantum-predicted action; and while the prediction error between the predicted perception data corresponding to the predicted future state of the artificially intelligent entity in which the artificially intelligent entity performs the quantum-predicted action and the actual perception data corresponding to the actual future state of the artificially intelligent entity in which the artificially intelligent entity performs the quantum-predicted action exceeds the threshold: transmitting a request to the quantum processing system to determine an additional quantum-predicted action of the artificially intelligent entity; receiving the additional quantum-predicted action; and controlling the artificially intelligent entity to perform the additional quantum-predicted action.

The artificially intelligent entity may be selected from a group consisting of: a physical embodiment, a robot, a virtual avatar, and a non-playable character in a virtual environment. The artificially intelligent entity may include a physical embodiment with at least one sensor and at least one actuator. The perception data may include sensor data from the at least one sensor. Controlling the artificially intelligent entity to perform the predicted action may include: defining control signals that, when received by the at least one actuator, cause the at least one actuator to perform the predicted action; and transmitting the control signals to the at least one actuator.

A computer program product may be summarized as including a non-transitory processor-readable storage medium storing a classical next-step prediction network and processor-executable instructions and/or data, wherein when: i) the non-transitory processor-readable storage medium is communicatively coupled to at least one classical processor of a control system that is communicatively coupled to both a quantum computing system and an artificially intelligent entity, and ii) the processor-executable instructions and/or data are executed by the at least one classical processor of the control system, the processor-executable instructions and/or data cause the control system to: process perception data corresponding to a state of the artificially intelligent entity; while a prediction error is below a threshold, iteratively: determine, by the classical next-step prediction network, a predicted action of the artificially intelligent entity; determine, by the classical next-step prediction network, predicted perception data corresponding to a predicted future state of the artificially intelligent entity; control the artificially intelligent entity to perform the predicted action; process actual perception data corresponding to an actual future state of the artificially intelligent entity; determine the prediction error between the predicted perception data and the actual perception data; when the prediction error exceeds the threshold: transmit a request to the quantum processing system to determine, by a quantum next-step prediction algorithm, a quantum-predicted action of the artificially intelligent entity; receive the quantum-predicted action; and control the artificially intelligent entity to perform the quantum-predicted action.

The artificially intelligent entity may include a physical embodiment and the computer program product may be carried on-board the physical embodiment. The processor-executable instructions and/or data, when executed by the at least one classical processor of the control system, may further cause the control system to: determine, by the classical next-step prediction network, predicted perception data corresponding to a predicted future state of the artificially intelligent entity in which the artificially intelligent entity performs the quantum-predicted action; process actual perception data corresponding to the actual future state of the artificially intelligent entity in which the artificially intelligent entity performs the quantum-predicted action; and update the classical next-step prediction network based on the quantum-predicted action and the actual perception data corresponding to the actual future state of the artificially intelligent entity in which the artificially intelligent entity performs the quantum-predicted action. In addition or in the alternative, the processor-executable instructions and/or data, when executed by the at least one classical processor of the control system, may further cause the control system to: when the prediction error exceeds the threshold: determine, by the classical next-step prediction network, predicted perception data corresponding to a predicted future state of the artificially intelligent entity in which the artificially intelligent entity performs the quantum-predicted action; process actual perception data corresponding to the actual future state of the artificially intelligent entity in which the artificially intelligent entity performs the quantum-predicted action; determine the prediction error between the predicted perception data corresponding to the predicted future state of the artificially intelligent entity in which the artificially intelligent entity performs the quantum-predicted action and the actual perception data corresponding to the actual future state of the artificially intelligent entity in which the artificially intelligent entity performs the quantum-predicted action; when the prediction error between the predicted perception data corresponding to the predicted future state of the artificially intelligent entity in which the artificially intelligent entity performs the quantum-predicted action and the actual perception data corresponding to the actual future state of the artificially intelligent entity in which the artificially intelligent entity performs the quantum-predicted action is below the threshold: update the classical next-step prediction network based on the quantum-predicted action and the actual perception data corresponding to the actual future state of the artificially intelligent entity in which the artificially intelligent entity performs the quantum-predicted action; and while the prediction error between the predicted perception data corresponding to the predicted future state of the artificially intelligent entity in which the artificially intelligent entity performs the quantum-predicted action and the actual perception data corresponding to the actual future state of the artificially intelligent entity in which the artificially intelligent entity performs the quantum-predicted action exceeds the threshold: transmit a request to the quantum processing system to determine an additional quantum-predicted action of the artificially intelligent entity; receive the additional quantum-predicted action; and control the artificially intelligent entity to perform the additional quantum-predicted action.

### BRIEF DESCRIPTION OF THE SEVERAL VIEWS OF THE DRAWINGS

The various elements and acts depicted in the drawings are provided for illustrative purposes to support the detailed description. Unless the specific context requires otherwise, the sizes, shapes, and relative positions of the illustrated elements and acts are not necessarily shown to scale and are not necessarily intended to convey any information or limitation. In general, identical reference numbers are used to identify similar elements or acts.

FIG. 1 is an illustration of an example hybrid quantum-classical control system for an artificially intelligent entity, in accordance with the present systems, methods, and computer program products;

FIG. 2 is a flowchart of an example hybrid quantum-classical control method, in accordance with the present systems, methods, and computer program products;

FIG. 3 is a schematic representation of the cognitive architecture of a quantum decision agent implemented in a hybrid quantum-classical control system for a physical embodiment, in accordance with the present systems, methods, and computer program products;

FIG. 4 is a schematic representation of an example of a cognitive architecture for a hybrid quantum-classical control system, in accordance with the present systems, methods, and computer program products;

FIG. 5 is a schematic depiction of a quantum decision agent implemented as a quantum Hebbian neural network, in accordance with the present systems, methods, and computer program products;

FIG. 6 is a schematic representation of a quantum processing unit making an action decision at a high level of motor control, in accordance with the present systems, methods, and computer program products;

FIG. 7 is a schematic representation of a quantum processing unit making an action decision at a low level of motor control, in accordance with the present systems, methods, and computer program products;

FIG. 8 is a block diagram of an example connection system of a hybrid quantum-classical control system to a physical embodiment hardware, in accordance with the present systems, methods, and computer program products;

FIG. 9 is a block diagram of an example computing infrastructure setup a hybrid quantum-classical control system, in accordance with the present systems, methods, and computer program products;

FIG. 10 is an example of the spin states of a 8-qubit quantum decision agent changing over time;

FIG. 11 is a graph of the energy of an Ising spin system decreasing over time when a Hebbian Learning algorithm is run on an annealing processor; and

FIG. 12 is a visualization of experimental data obtained from a quantum decision agent with an example of a system described in the present systems, methods, and computer program products.

FIG. 13A is a flow diagram showing an exemplary computer-implemented method to control an artificially intelligent entity in accordance with the present systems, methods, and computer program products.

FIG. 13B is a flow diagram showing an exemplary computer-implemented method to control an artificially intelligent entity in accordance with the present systems, methods, and computer program products.

FIG. 13C is a flow diagram showing another exemplary computer-implemented method to control an artificially intelligent entity in accordance with the present systems, methods, and computer program products.

FIG. 14 is a schematic diagram of an illustrative example of a hybrid classical-quantum architecture that may implement the various methods and computer program products described herein.

### DETAILED DESCRIPTION

The following description sets forth specific details in order to illustrate and provide an understanding of the various implementations and embodiments of the present systems, methods, and computer program products. A person of skill in the art will appreciate that some of the specific details described herein may be omitted or modified in alternative implementations and embodiments, and that the various implementations and embodiments described herein may be combined with each other and/or with other methods, components, materials, etc. in order to produce further implementations and embodiments.

In some instances, well-known structures and/or processes associated with computer systems and data processing have not been shown or provided in detail in order to avoid unnecessarily complicating or obscuring the descriptions of the implementations and embodiments.

Unless defined otherwise, all technical and scientific terms used herein have the same meaning as commonly understood by one of ordinary skill in the art to which the present systems, methods, and computer program products belongs. Working examples provided herein are considered to be non-limiting and merely for purposes of illustration.

As used in the specification and claims, the singular forms “a”, “an” and “the” include plural references unless the context clearly dictates otherwise.

The term “comprise” and any of its derivatives (e.g. comprises, comprising) as used in this specification is to be taken to be inclusive of features to which it refers, and is not meant to exclude the presence of any additional features unless otherwise stated or implied. The term “comprising” as used herein will also be understood to mean that the list following is non-exhaustive and may or may not include any other additional suitable items, for example one or more further feature(s), component(s) and/or element(s) as appropriate.

As used herein, the terms “having,” “including” and “containing,” and grammatical variations thereof, are inclusive or open-ended and do not exclude additional, unrecited elements and/or method steps, and that that the list following is non-exhaustive and may or may not include any other additional suitable items, for example one or more further feature(s), component(s) and/or element(s) as appropriate. A composition, device, article, system, use, process, or method described herein as comprising certain elements and/or steps may also, in certain embodiments consist essentially of those elements and/or steps, and in other embodiments consist of those elements and/or steps and additional elements and/or steps, whether or not these embodiments are specifically referred to.

As used herein, the term “about” refers to an approximately +/−10% variation from a given value. It is to be understood that such a variation is always included in any given value provided herein, whether or not it is specifically referred to. The recitation of ranges herein is intended to convey both the ranges and individual values falling within the ranges, to the same place value as the numerals used to denote the range, unless otherwise indicated herein.

The use of any examples or exemplary language, e.g. “such as”, “exemplary embodiment”, “illustrative embodiment” and “for example” is intended to illustrate or denote aspects, embodiments, variations, elements or features relating to the present systems, methods, and computer program products and not intended to limit the scope thereof.

As used herein, the terms “connect” and “connected” refer to any direct or indirect physical association between elements or features of the present systems, methods, and computer program products. Accordingly, these terms may be understood to denote elements or features that are partly or completely contained within one another, attached, coupled, disposed on, joined together, entangled with, in communication with, operatively associated with, etc., even if there are other elements or features intervening between the elements or features described as being connected.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removably affixed solid-state storage drives; an object; an executable; a thread of execution; a computer-executable program, and/or a computer. Both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). A component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. A component can also be an apparatus that provides specific functionality through electronic components without mechanical parts, the electronic components can include a processor therein to execute software or firmware that provides at least in part the functionality of the electronic components. Interface(s) can include, for example, input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the term “agent” refers to a system of software (e.g., an application or program) that uses artificial intelligence (AI) to pursue goals and complete tasks. It is common for an agent to leverage reasoning, planning, and/or memory, and/or to have a level of autonomy to make decisions, learn, and/or adapt.

As used herein, the term “entity” refers to a system under control by at least one agent. An entity may have a physical embodiment having at least one sensor for sensing an environment around itself and capable of reaction based on input to the sensor. The entity can be, for example, a physical robot, virtual robot, avatar, non-playable character in a virtual world (e.g., in a video game), sensorimotor construct, or autonomous mechanical construct, which in any case can be controlled by the present control system. In general, an entity that is controlled by an agent is referred to here as an “artificially intelligent entity”. In some implementations, the entity can be or include a user interface on a device, where the device comprises, for example, a keyboard-mouse-screen interface, a touchscreen interface such as a cellphone or tablet interface, or hand and head trackers on a VR headset. In a user interface embodiment, the sensor data could be obtained from pixels on the screen and the actuation output of the agent could be any type of data output, including but not limited to click locations and type, keyboard keystrokes, or audio sent into the device microphone.

Throughout this specification and the appended claims, the term “action” is used in a general sense to refer to the initialization, performance, and/or completion of an activity. Depending on the specific instance, an “action” may be a physical action involving physical motion or locomotion, or an action may be non-physical involving no motion or locomotion at all. In some instances, an action may have an effect on an artificially intelligent entity's body (whether that body is real or virtual) and/or external environment (whether that environment is real or virtual)-such as a change in pose or position. In some instances, an action may have no effect on an artificially intelligent entity's body or external environment and instead involve only internal processes-such as planning, computation, calculation, inference, and the like. As further examples, an action can include a physical action that controls an external hardware process (real or virtual), such as displacement, end effector control, repositioning, and so on- or an action can include a non-physical action that controls an internal software process, such as communication, task/motion planning, object analysis, and so on.

The headings and Abstract of the Disclosure are provided for convenience only and are not intended, and should not be construed, to interpret the scope or meaning of the present systems, methods, and computer program products.

Herein is described various implementations of a hybrid quantum-classical control system for an artificially intelligent entity. The present system addresses the challenges of understanding and decision-making in artificially intelligent entities (including but not limited to physical embodiments) in situations outside of those seen in classical artificial intelligence (AI) training data. Specifically, by integrating quantum computing principles into AI (e.g., and robotics where applicable) to simulate decision-making processes, a quantum decision agent can assist the artificially intelligent entity (e.g., physical or virtual embodiment) with decision-making when there is no reasonable precedent in a pattern library to instruct the artificially intelligent entity (e.g., physical or virtual embodiment) on how to proceed. In this way, decision-making and learning in edge-cases that are outside of training data or prior experience of a classical AI system can be assisted or augmented by a quantum decision agent, and in any step of a process where there is insufficient training data from a classical AI decision agent. Without being bound by theory, the present system and method can enable decision-making in artificially intelligent systems in a way that requires less training data than classical approaches.

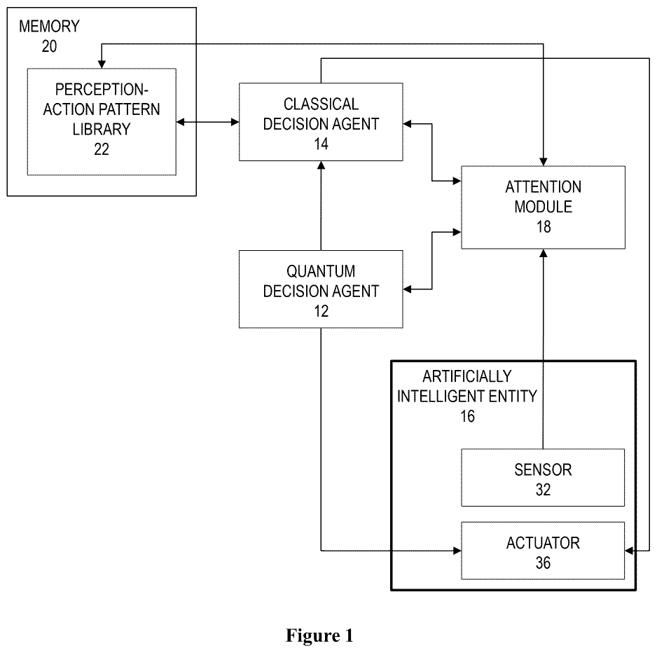

FIG. 1 is an illustration of an example hybrid quantum-classical control system for an artificially intelligent entity (e.g., physical or virtual embodiment) 16. The control system comprises a quantum decision agent 12 and classical decision agent 14 which together inform an attention module 18 to direct the action of the artificially intelligent entity (e.g., physical or virtual embodiment) 16. Sensor 32 on the artificially intelligent entity (e.g., physical or virtual embodiment) 16 receives sensor input about the environment of the artificially intelligent entity (e.g., physical or virtual embodiment) 16 and provides that sensor input to the attention module 18, which can utilize the quantum decision agent 12 and classical decision agent 14 to direct a suitable action to the artificially intelligent entity (e.g., physical or virtual embodiment) 16.

The classical decision agent 14, which can comprise a classical AI decision agent, is connected to one or more memory 20, which comprises a perception pattern library 22, an action pattern library 24, and a sensorimotor pattern library 26. The classical decision agent may be implemented in a single system such as an artificial neural network, where in some embodiments the classical decision agent can update the artificial neural net model weights, and the classical decision agent can use the artificial neural net model weights for inference. The classical decision agent 14 can comprise a classical artificial intelligence (AI) that can be run in learning mode, where training data is supplied to train the agent, and/or in inference mode. The perception-action pattern library 22 can, in some embodiments, be equivalent to the model weights of a neural network. In an example, the classical decision agent 14 can run in inference mode, whereby it uses an existing perception-action library to arrive at a suitable action command, optionally using a trained neural network. In another example, the classical decision agent can run in training mode, whereby it can update the perception-action library. Information from the quantum decision agent 12 can be used to supply training data to the perception-action pattern library used by the classical decision agent.

In one example, the quantum decision agent 12 can be run on a gate model quantum processor, wherein the connections between the plurality of input qubits and the plurality of output qubits comprise a set of parameterized quantum gates together forming a quantum circuit. In another example, the connections between the plurality of input qubits and the plurality of output qubits in the quantum decision agent 12 can comprise a set of couplings between spin states on a quantum annealing based processor.

In practice, in a decision-making requirement from the artificially intelligent entity (e.g., physical or virtual embodiment) 16, a query from the attention module 18 through the classical decision agent 14 can engage memory 20 to determine if a perception pattern is recognizable at a certain threshold, and if so, if the recognized perception pattern has a related action pattern. A similar query can call on the sensorimotor pattern library 26 to determine if a particular sensorimotor pattern exists that is relevant to the sensor input from sensor 32. If there is no pattern match of perception pattern or sensorimotor pattern, the attention module 18 can call upon the quantum decision agent 12 to assist with decision making based on the sensor data from the sensor 32 on the artificially intelligent entity (e.g., physical embodiment or virtual embodiment) 16. The attention module 18 can thereby receive and process information from the artificially intelligent entity (e.g., physical or virtual embodiment) and select which subset of information to route to either the quantum decision agent or the classical decision agent. To decide whether the information should be sent to the quantum decision agent 12 or the classical decision agent 14, the attention module 18 can query the perception-action pattern library 22 to see if there is an existing pattern that matches to within a desired threshold.

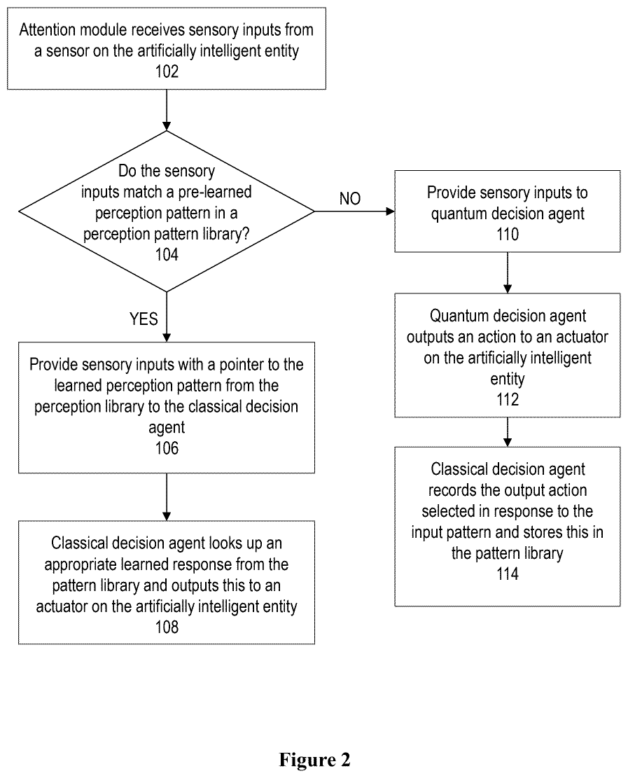

FIG. 2 is a flowchart of an example hybrid quantum-classical control method. In a first step the attention module receives sensory inputs from a sensor on the artificially intelligent entity (e.g., physical or virtual embodiment) 102. The attention module then queries if the sensory inputs match a pre-learned perception pattern in a perception pattern library 104. If not, then the sensory inputs are provided to a quantum decision agent for decision-making 110. If yes, then sensory inputs are provided with a pointer to the learned perception pattern from the perception library to the classical decision agent 106. The classical decision making module then looks up an appropriate learned response from the pattern library and outputs this to an actuator on the artificially intelligent entity (e.g., physical or virtual embodiment) 108.

If, however, the pre-learned perception does not match to a known sensorimotor response 106, then the sensory inputs are provided to the quantum decision agent 110. The quantum decision agent then outputs an action to an actuator on the artificially intelligent entity (e.g., physical or virtual embodiment) 112, and the classical learning module records the output action selected in response to the input pattern and stores this in the pattern library 114.

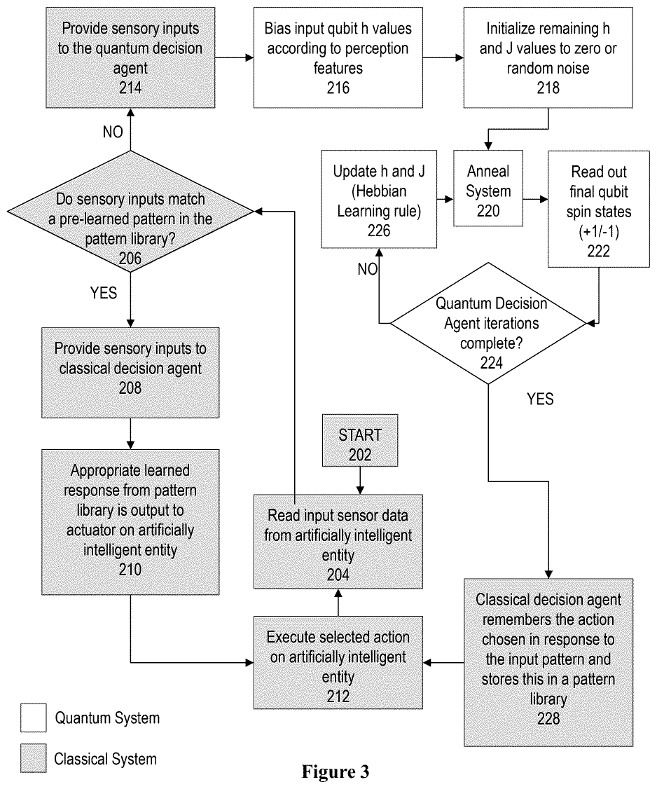

FIG. 3 is a schematic representation of the cognitive architecture of a quantum decision agent implemented in a hybrid quantum-classical control system for an artificially intelligent entity (e.g., a physical or virtual embodiment). A quantum decision agent, which optionally contains a Hebbian learning agent, can be implemented algorithmically on a quantum processing unit. A Hebbian learning agent is an artificial intelligence model inspired by the principle of Hebbian learning, which posits that the synapses between biological neurons strengthen when they are activated simultaneously. A similar methodology can be applied in quantum learning. In particular, a quantum Hebbian learning agent can be capable of adapting its connections and behaviors based on the correlations observed in input data, allowing it to learn patterns and enhance its performance over time through associative mechanisms. In the quantum decision agent, a combination of input qubits and output qubits, which have varying influence and varying strengths of connection, can be used in a quantum learning methodology for a non-biological physical embodiment.

To control an artificially intelligent entity (e.g., a physical or virtual embodiment), a connected attention module which receives sensor information from the artificially intelligent entity (e.g., physical or virtual embodiment), can access either the quantum decision agent or the classical decision agent for assistance in determining an appropriate action in response to a sensor input. The classical decision agent can be implemented algorithmically on a classical processor, such as a central processing unit (CPU) or graphical processing unit (GPU). The classical decision agent can operate in learning mode to learn feature patterns, action patterns, and sensorimotor patterns, which are combinations of feature and action patterns, and store these in a perception pattern library, action pattern library, and/or sensorimotor pattern library. This classical memory system comprising a feature pattern library, action pattern library and sensorimotor pattern library can store pre-seeded and learned patterns. The classical decision agent can also together comprise a classical artificial intelligence learning loop or classical neural network.

The attention module decides whether to farm out decision making to the quantum decision agent or to the classical decision agent based on whether a feature as obtained from one or more sensors on the artificially intelligent entity (e.g., physical or virtual embodiment) matches one or more feature pattern or sensorimotor pattern in the connected libraries. The system begins at START 202. Sensory inputs from the environment of the artificially intelligent entity (e.g., physical or virtual embodiment) are fed into the attention module 204. First, the attention module determines whether the perception pattern being attended to is recognized or not, i.e. matches a pre-learned pattern, then the attention module checks whether a pre-learned pattern corresponds to a known sensorimotor response 206. If a known sensorimotor response exists, sensory inputs are provided to the classical decision agent 208, the appropriate learned response from a pattern library is output to an actuator on the artificially intelligent entity (e.g., physical or virtual embodiment) 210, and the attention module will execute the action component of the matching sensorimotor pattern on an actuator on the artificially intelligent entity (e.g., physical or virtual embodiment) 212. If a known sensorimotor response does not exist, but the feature pattern is recognized, the attention system will send the pointer to the learned feature pattern into the quantum decision agent 214. In this case, the quantum decision agent will choose an action output and send a control signal to the artificially intelligent entity (e.g., physical or virtual embodiment) to enact the action output. A copy of the feature pattern and the chosen action pattern can also be sent to the classical decision agent for it to remember and be stored in one or more of the pattern libraries or to be provided to a neural network for training. In the quantum decision agent input h values are biased according to perception features 216 and remaining h and J values are initialized to zero or random noise 218. The quantum system can then be annealed 220 and the final qubit spin states (+1/−1) can be read out 222. The system can then query whether the quantum decision agent iterations are complete 224. If the quantum decision agent iterations are complete, then the classical decision agent can be set to remember the action chosen in response to the input pattern and optionally store the chosen action and response in a pattern library 228. If the quantum decision agent iterations are not complete, then the h and J values can be updated 226 and the quantum system can be again annealed 220.

A person of skill in the art will appreciate that, in the context of an artificially intelligent entity, references to “sensors” and “actuators” and “environment” apply to real physical sensors and actuators and environments when the artificially intelligent entity has a physical embodiment (such as a robot) and apply to simulated sensors and actuators and environments (or more generally to software that, when executed, represents sensing and actuation functions and a virtual environment) when the artificially intelligent entity has a virtual embodiment (such as an avatar or non-playable character).

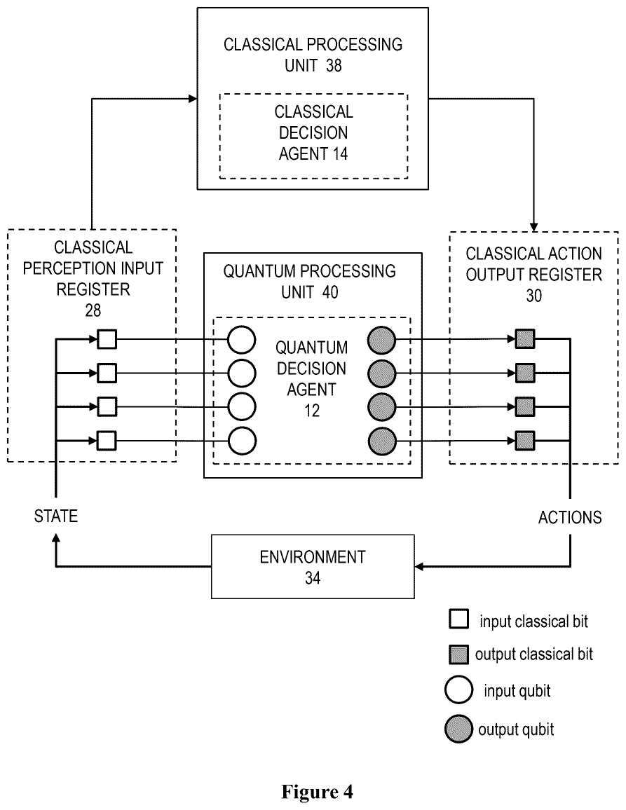

FIG. 4 is a schematic representation of an example of a cognitive architecture for a hybrid quantum-classical control system. Connections between a quantum decision agent 12 and a classical decision agent 14 are shown as an artificial learning loop in a hybrid classical-quantum control system in the environment 34 of an artificially intelligent entity (e.g., a physical or virtual embodiment). A sensor on the artificially intelligent entity (e.g., physical or virtual embodiment) receives sensor input from an environment 34 of an artificially intelligent entity (e.g., physical or virtual embodiment) which provides data on the state of the artificially intelligent entity (e.g., physical or virtual embodiment). Sensors on the artificially intelligent entity (e.g., physical or virtual embodiment) which can provide state data include but are not limited to one or more cameras, microphones, temperature sensors, balance or orientation sensors, LIDAR or SONAR sensors, depth sensors, touch sensors, motor position sensors, torque sensors, strain sensors, current or voltage sensors, proximity sensors, acceleration sensors, chemical detection sensors, pH monitors, buttons, switches, knobs, magnetic sensors, optical sensors (e.g. an optical mouse), touch screen sensors, keyboard input, or mouse click detection. This state data is sent to a classical perception input register 28 in the form of classical bits, shown as four boxes in the classical perception input register 28. In a classical learning decision-making process, these classical bits are sent to classical processing unit 38 comprising classical decision agent 14, which performs a pattern matching to existing perception (sensor), sensorimotor, and/or action patterns. This matching can be done, for example, with a neural network, classical artificial intelligence, look up table, mathematical function, or other system. If no pattern is found, the same set of classical bits can be input into a quantum decision agent 12 in a quantum processing unit 40. In the quantum processing unit 40 the input classical bits can be converted into input qubit biases, shown as open circles, which are processed in a quantum and returned as output qubits, shown as shaded circles. The output qubit values (states) can then be sent to classical action output register 30 for conversion to a classical output bit, and sent to the artificially intelligent entity (e.g., physical or virtual embodiment) to invoke an action output. An action output can be, for example, a motor output, or other types of actions, for example control of sound, lights, feedback in the form of sound notifications, text, or video, changing of power modes, controlling the position of a cursor on a screen, inputting text into an on-screen text box, etc. Other outputs can include software actions internal to the agent, for example, switching attention focus to different sub-parts of the perception input, using the classical memory system to make predictions, changing the parameters of the agent's neural net (examples include number of layers, learning rate, size of each layer) or recalling memories. Output devices that effect an action output can include but are not limited to one or more motors, piezo-electric actuators, light, speaker, heater, screen or other graphical user interface, vibration and buzzers, etc. Pattern encoders can run either on the hardware of a physical embodiment or on a local desktop or cloud, or may be split across two or more computing resources, depending on the processing power and bandwidth available on each device.

Once the action outputs have been updated by the quantum decision agent 12, the classical decision agent 14 can then execute an action determined based on the input state. The action is then sent to the artificially intelligent entity (e.g., physical or virtual embodiment), where it performs or otherwise implements the selected action. The selected action can also be entered as values to update the perception system based on the interaction of the artificially intelligent entity with the environment. Perception patterns returned from the environment are stored as bitstrings, and a classical pattern recognition model can observe and remember commonly occurring patterns as a classical sensorimotor pattern recognition system.

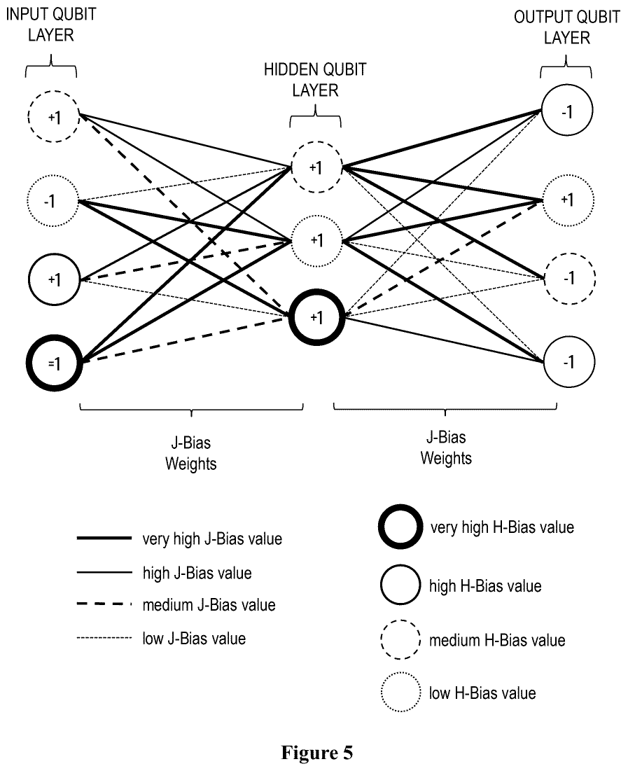

FIG. 5 is a schematic depiction of a quantum decision agent implemented, for non-limiting exemplary purposes, as a quantum Hebbian neural network with four input qubits, three hidden qubits, and four output qubits. The quantum decision agent shown has three layers: an input qubit layer; a hidden qubit layer; and an output qubit layer (as identified in FIG. 5), with eleven qubits in total. Each qubit is represented in FIG. 5 by a respective circle, and the qubit state of each qubit is shown as the number inside the circle. An input qubit is one that can be strongly biased by a classical bit of information such that it is prepared in the quantum state |0>or |1>. An output qubit is one that exists in a superposition state, but can be measured (with respect to the basis of classical information defined over the input bits), in order to produce a classical bit of information, 0 or 1.

A hidden qubit is one that is not directly connected to the outside world, and cannot be influenced by information without that information having to go through the boundary qubits, hence the term “hidden”. Hidden qubits are analogous to hidden layers in a neural network. There can be zero, one or more hidden layers. Pairs of qubits are connected by variable coupling terms, also referred to as weights-represented by straight lines connecting in between pairs of qubits in FIG. 5. Similar to a classical neural net, weights denote how strongly the bits are connected to each other, and how much their state influences the states of their neighbors. The weight of the connection between qubits are referred to as J-values in the algorithmic description, where some qubits are connected with very high J-Bias weights, and others with lower J-Bias weights, as shown. Each of the input, output, and hidden bits also have an associated H-Bias terms or strength, referred to as H-values in the algorithmic description. A high H-bias term, or qubit strength, favors a qubit towards ending up in one state versus another.

Information sent into the quantum neural network, also referred to as an annealing quantum processing unit, can be put into a highly quantum mechanical state, with the qubits demonstrating superposition and entanglement. In this artificially intelligent quantum neural network, the input qubits are populated, and the system is allowed to entangle in superposition such that the input qubits, hidden qubits, and output qubits are entangled. In an annealing process the quantum neural network reaches a decision-making point, whereupon the system performs a measurement over the action output qubits, collapsing the wave function and selecting an action. The product of the annealing process is dependent on both the J-Bias weights and H-Bias strengths of the quantum neural network, which provides the Hebbian learning component of the quantum decision agent.

For annealing, in an annealing processor, the system starts in what is called the x-basis in quantum mechanics. In this basis, all qubits are put into a superposition of 0 and 1. The basis is then slowly changed to what is known as the measurement (or z) basis, at which point the qubits will all end up in a classical state of 0 or 1. The system will stay in a low energy state during this annealing process. Quantum annealing processors are purported to be able to find lower energy states than their classically simulated counterparts due to the presence of superposition and entanglement, which allows the system to “quantum mechanically tunnel” out of an energy local minimum into a lower energy configuration. The energy state that the quantum neural network ends up in may not be the lowest energy state due to factors such as thermal and other sources of noise or bias, but that the final state chosen may be the one that attempts to minimize the energy of the quantum neural network. This action selection uses the built-in ability of physics to minimize the energy of a system, in lieu of having to encode a reward function anywhere in the system.

The quantum learning algorithm embodied by the quantum decision agent may, as a non-limiting example, provide a Hebbian learning process. This Hebbian learning process may happen within the quantum decision agent at a certain rate t_{Ψ} that is native to the agent. In the Hebbian learning process, first the input bits are sampled from the input perception register and encoded into h biases on the input qubits. For example, if the bit 1 was presented to Input 1, this could be stored in the input 1 bias register as a h-value of −1. The H-biases of all other qubits, i.e. the hidden qubits and output qubits are set to random values or zero. The J-values of all qubit-qubit weights are also set to random values or zero. Then the quantum annealing process is run on the system. At the end of the anneal, all qubits, i.e. the input qubits, hidden qubits, and output qubits, collapse into states +1 or −1. To update the quantum decision agent as a Hebbian learning agent, the weights or J-Bias values that connect the qubits to each other and the H-bias values that favor each qubit towards one classical state can then be updated according to a Hebbian Learning rule based on the spin states that the qubits ended up in. For example, if q1=+1 and q2=+1, the J value between these two qubits could be modified slightly to favor alignment, and the h value of both q1 and q2 would be modified slightly towards favoring a +1 state on the next anneal. The modification amounts are weighted by adjustable J and H learning rate parameters and an optional decay rate parameter. To train the quantum decision agent successive quantum annealing processes can be run for a number of user-defined iterations N using the same input perception values. The final values of output qubits after are N iterations encoded into the output action register.

An optional reward function can also be used to augment the quantum learning algorithm or, when applicable, Hebbian learning loop as described. In the algorithm described above, which can be considered as a reward-free case, the reward function of the system is captured in the energy dynamics of the quantum processor, i.e. the system naturally selects an action by self-minimization towards an attractor state, discovering H and J parameters along the way. In this way, Hebbian learning on a processor that implements quantum mechanics to select an action can be viewed as similar to how life may use quantum mechanics to select action. In this case life does not need a built in reward function. Other ways may also be used to implement a reward function in the system. In one example, the reward-function-free Hebbian learning agent could be replaced by an optional externally programmed reward function, where the system finds the lowest energy of a pre-specified reward function mapped into H and J parameters. This can be referred to as energy programming in an adiabatic quantum computing/quantum annealing paradigm, where the best action selection corresponds to the lowest energy state of the qubits according to the H and J values that are set by the machine learning system. Another method to implement a reward function is to modify the Hebbian Learning to include a component provided by an external reward function.. This can be viewed as similar to reinforcement learning approaches. In this case the quantum decision agent could still perform the quantum learning algorithm as described, with the exception that the H and J weights could be updated proportional to the reward that was obtained on the next timestep. In this case for example, at t=0, a particular state is read in, and an action is chosen. Then at t=1, the reward for taking that action comes back into the system and then the weights are updated according to what the reward was. This causes the system to “learn” a set of H and J weights that includes contributions both from the reward-free configuration and the external reward function.

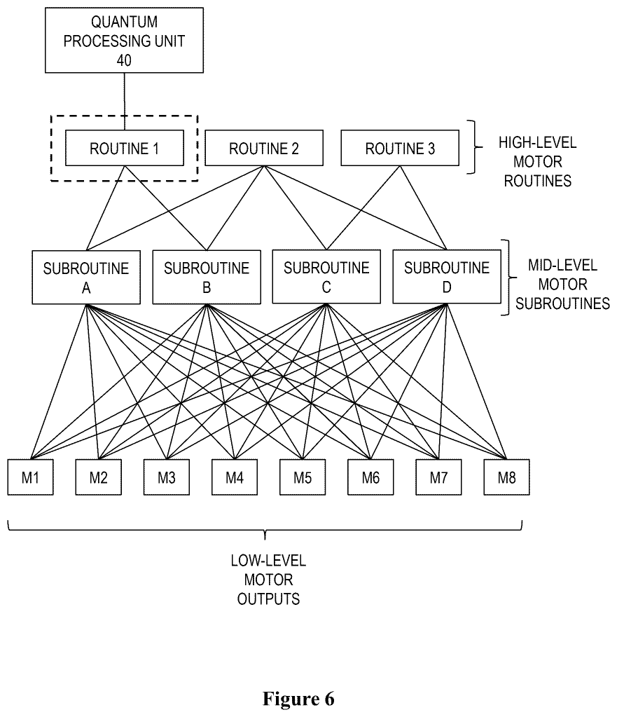

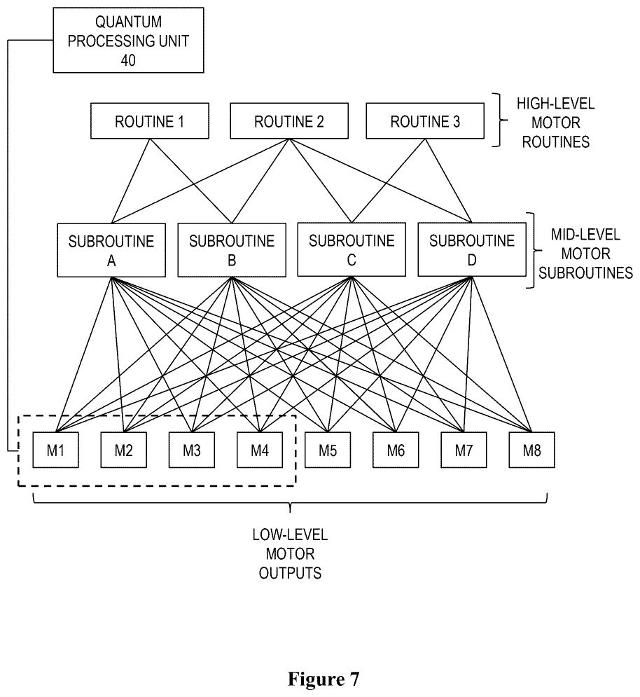

FIG. 6 is a schematic representation of a quantum processing unit making an action decision at a high level of motor control. As the quantum learning algorithm is developed further, the decision making process may be more complex and span both the classical decision agent and the quantum decision agent. For example, there may be a hierarchy of actions that are “unrolled” into individual motor updates through several levels. High-level motor control routines are represented in FIG. 6 (and in FIG. 7) as boxes labelled “Routine #”, mid-level motor control subroutines are represented in FIG. 6 (and in FIG. 7) as boxes labelled “Subroutine #”, and low-level motor outputs are represented in FIG. 6 (and in FIG. 7) as boxes labelled “M #”. The quantum decision agent may be able to make decisions to invoke actions at any level of the hierarchy. In the example in FIG. 6, the quantum processing unit 40 comprising the quantum decision agent intervenes to problem solve via a high-level action at Routine 1, and then the details of this action are unrolled through the hierarchy into low-level motor commands by the classical processor. In an example, if a robot is asked to obtain all of the red balls in a multi-colored set of balls and move them to a bin, a variety of sensor data acquisitions and responsive actions are required by the robot to perform the task. In this example, a robot may already have a routine for identifying a ball (i.e. from a group of objects that are not balls), identify the color “red”, and move an object to a bin, but may not have a routine for grasping a ball in particular. A high level motor routine for grasping a ball may be significantly different from a similar high level motor routine for grasping a book or a plush toy, and the quantum processing unit can be used at a high level routine layer to assist the robot in selecting an appropriate action for grasping a ball.

FIG. 7 is a schematic representation of a quantum processing unit making an action decision at a low level of motor control. In the example in FIG. 7, the quantum processing unit 40 takes control of problem solving and making a decision at a low level motor command directly involving motor control outputs M1, M2, M3, and M4. In the ball selection example above, the robot may already have a routine for grasping a ball, but the routine may be patterned after one for small steel ball bearings and the task at hand may involve larger plastic whiffle balls. When the system is in a state that does not “match” any of the corresponding routines, the quantum processing algorithm can “drop down” to a lower level of control. So if the required action of “grasp ball” does not yield a pattern matched set of sensory predictions along the way, the quantum learning algorithm can drop down to decision making at a lower level, such as at a motor control level. In this example, the motor speed, grasping digit configuration, and grasping strength can be adjusted to enable the robot or physical embodiment (or virtual embodiment) to change its action pattern to accommodate a larger, lighter, more fragile ball than one it has previously grasped.

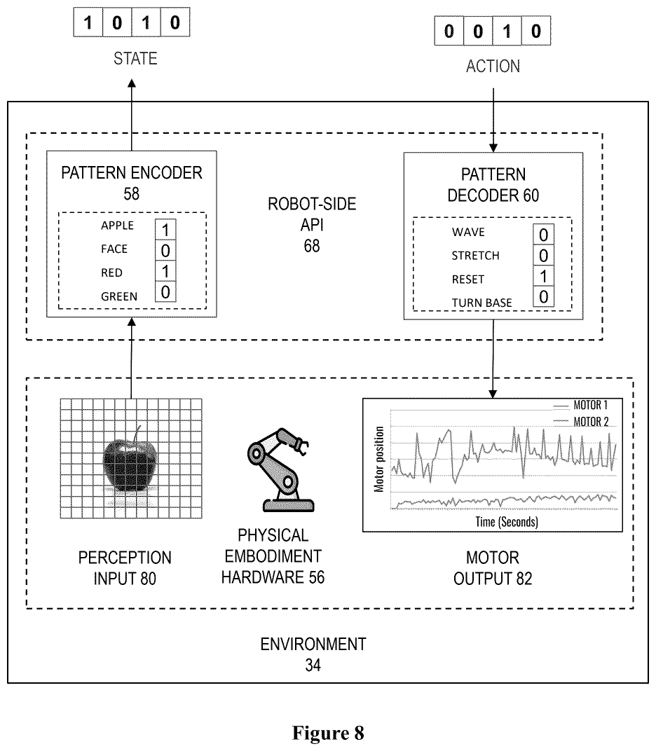

FIG. 8 is a block diagram of an example connection system of a hybrid quantum-classical control system to an artificially intelligent entity (i.e., physical embodiment hardware in the illustrative example of FIG. 8). This example system setup illustrates one configuration showing which parts of the system run on which physical computing resources and where these resources are located. The physical embodiment or robot in environment 34 is shown with a physical embodiment hardware 56 and robot-side application programming interface (API) 68. The physical embodiment hardware 56 has a sensor or perception input 80 to receive an environment state, and a motor output 82 to effect an action. Robot-side API 68 has a pattern encoder 58 to encode the state received from the perception input 80, and a pattern decoder 60 to receive the coded result action of the control system having the classical decision agent and quantum decision agent and converting it to a control signal to effect and action at the motor output 82. Although this example has a motor as an example action effector, it is understood that the action may be done on any output device as described herein. Pattern encoders may also be run either on the robot or physical embodiment hardware or on the local desktop or external connected processor, or may be split across two or more resources, depending on the processing power and bandwidth available on each device and system design.

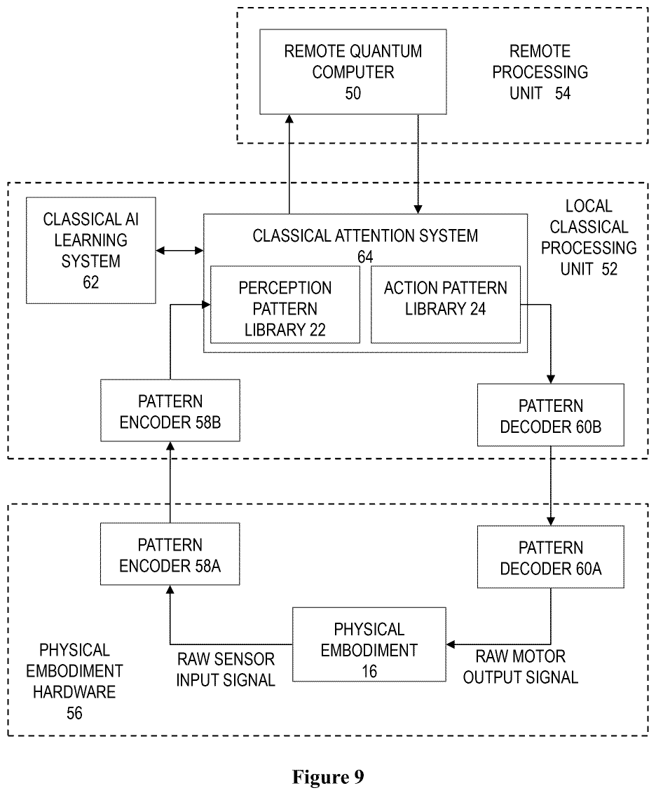

FIG. 9 is a block diagram of an example computing infrastructure setup for a hybrid quantum-classical control system. In this illustrative example configuration of components, physical embodiment 16 on a physical embodiment hardware 56, having a sensor as the input device and a motor as the output device, sends a raw sensor input to pattern encoder 58A. This signal is then sent to pattern encoder 58B on a local classical processing unit 52 where it is input into a classical attention system 64. The classical attention system 64 is connected to a perception pattern library 22 and an action pattern library 24, where the input signal can be matched, if possible, to an existing perception pattern such that a suitable action pattern can be selected. A classical AI learning system 62 may also be used to find a suitable match. If no suitably matched perception pattern exists in the perception pattern library a remote processing unit 54 having a remote quantum computer 50 may be accessed to process the input signal on a quantum decision agent. It is understood that in future quantum processing units may also be local on the classical processing unit 52 and/or the physical embodiment hardware 56. Once an action is selected based on the sensor input, pattern decoder 60B on the local classical processing unit 52 can provide an action signal to pattern decoder 60A on the physical embodiment hardware 56 to effect a raw motor output signal to drive action on the physical embodiment hardware.

It is understood that a broad range of variations to the present system may be used, such as varying condition, structure, design, hardware, and method. In some embodiments, the number of input, output and hidden qubits can be varied, and the structure of the network itself (including the number of hidden layers) can be varied. The rate of measurement of the system (annealing rate), and the form of the annealing function can be varied. The classical AI subroutines can be either learned or pre-programmed subroutines, or optionally nested in a hierarchy of pointers to one another, allowing the quantum decision making to occur at multiple different levels of abstraction. The form of the physical robot or physical embodiment can vary and can have a small or large number of degrees of freedom, with many different types of sensor or input devices and many types of action effector devices. In the quantum system the way in which the qubits are implemented can differ, for example replacing the standard discrete qubit (where the output is either 0 or 1) with a continuous-value qubit where the output can be a real number, as used in continuous variable quantum computers.

In some embodiments a smaller part of the perception pattern input can be sub-selected for input into the quantum decision agent. Choosing the parameters for this sub-selection process can themselves be an action choice of the system, which can be selected by the quantum decision agent or by the classical decision agent. A Hebbian Learning algorithm may also be replaced with an equivalent gate model, also referred to as a circuit model, quantum computing learning algorithm, where instead of adjusting the weights and biases of an annealing-based quantum neural network, the results from one iteration of the quantum circuit are used to modify the parameters of the quantum circuit on the next iteration. Other variations are also conceivable.

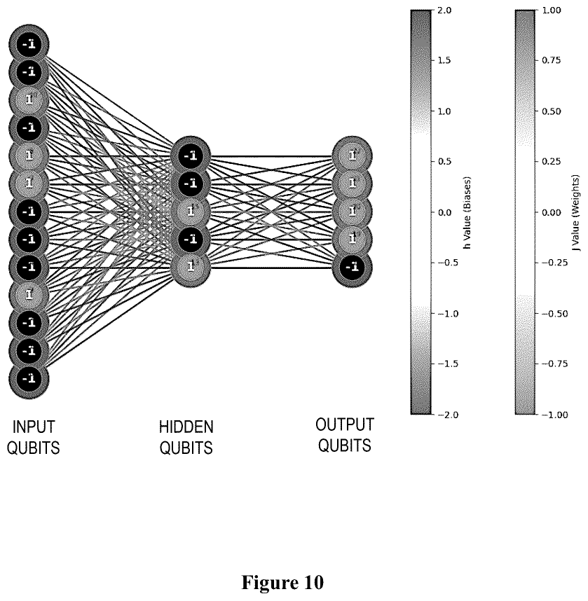

FIG. 10 is an illustrative example of a visualization of a 23-qubit quantum decision agent after an exemplary Hebbian Learning run on a simulation of the D-Wave quantum annealing hardware, showing 13 input qubits, 5 hidden qubits, and 5 output qubits, together with the final H values, J values and spin states. This experimental system was established during a 500-iteration Hebbian Learning run on a simulation of the D-Wave quantum annealing processor.

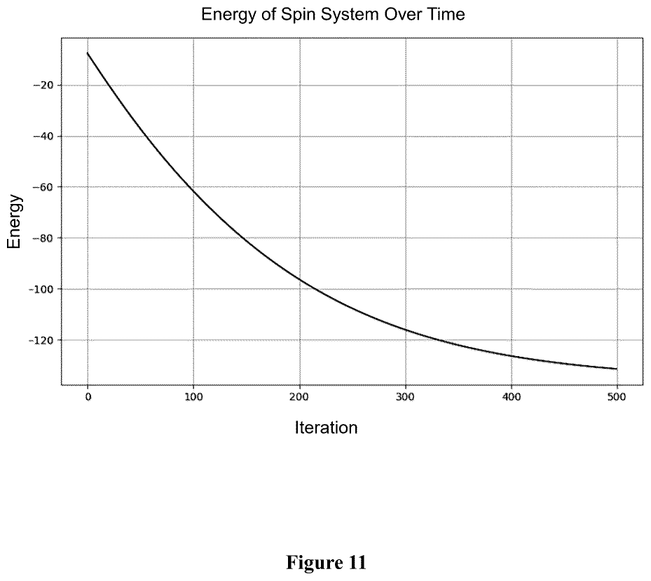

FIG. 11 is an illustrative example of a graph of the energy of an Ising quantum processing unit spin system over time when a Hebbian Learning algorithm with 500 iterations is run on an annealing processor.

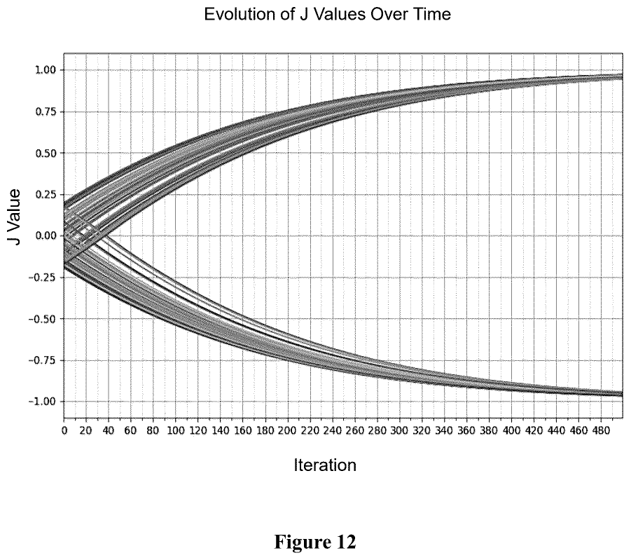

FIG. 12 is an illustrative example of a visualization of experimental data obtained from a quantum decision agent with the present system. This example illustrates the J values, or quantum neural network weights, of a quantum decision agent converging during a 500-iteration Hebbian Learning run on a simulation of the D-Wave quantum annealing processor.

The various implementations described herein include systems, methods, and computer program products that leverage both classical processing and quantum processing to support autonomous control of an artificially intelligent entity. Conventional autonomous control systems, methods, and computer program products typically exclusively employ classical processing and are therefore constrained by, for example, the limited computational capacity of classical processing. In accordance with the present systems, methods, and computer program products, quantum processing resources may be leveraged to cure the deficiencies of classical processing in autonomous control systems. In particular, quantum processing resources may be invoked when conventional classical processing resources fail to deliver a suitable result, and in some implementations the result provided by quantum processing resources may be used to train or otherwise improve the classical processing resources.

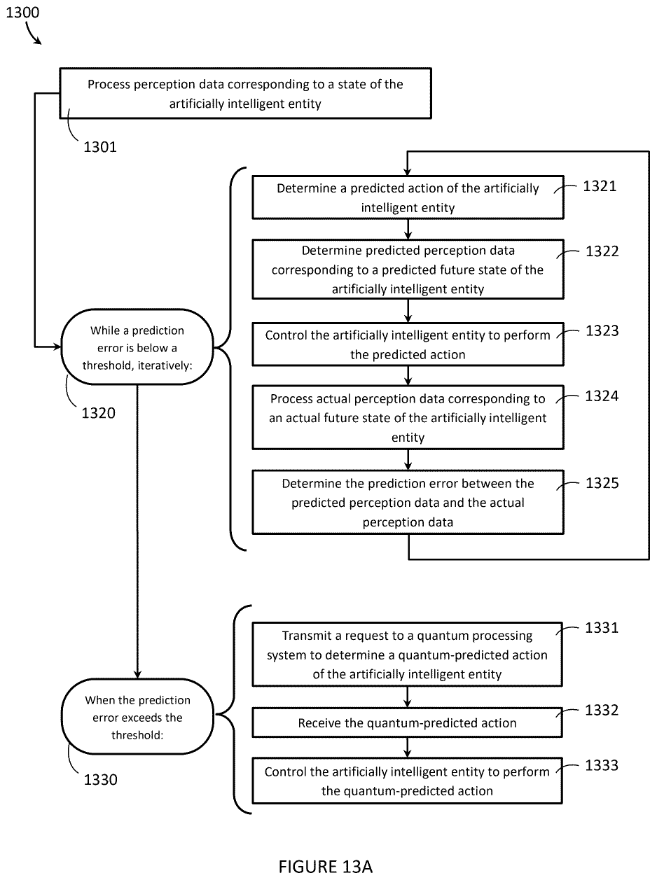

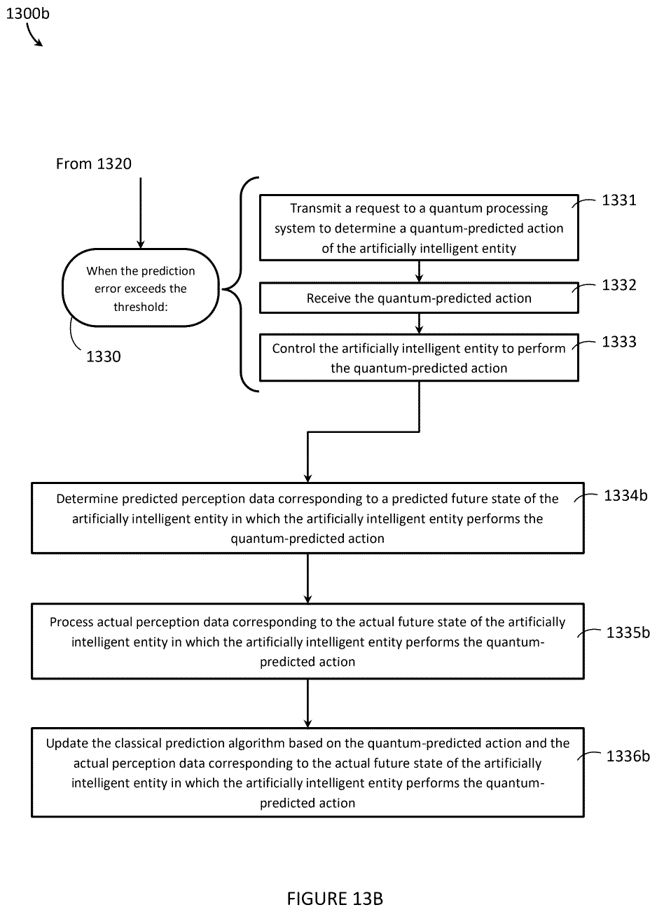

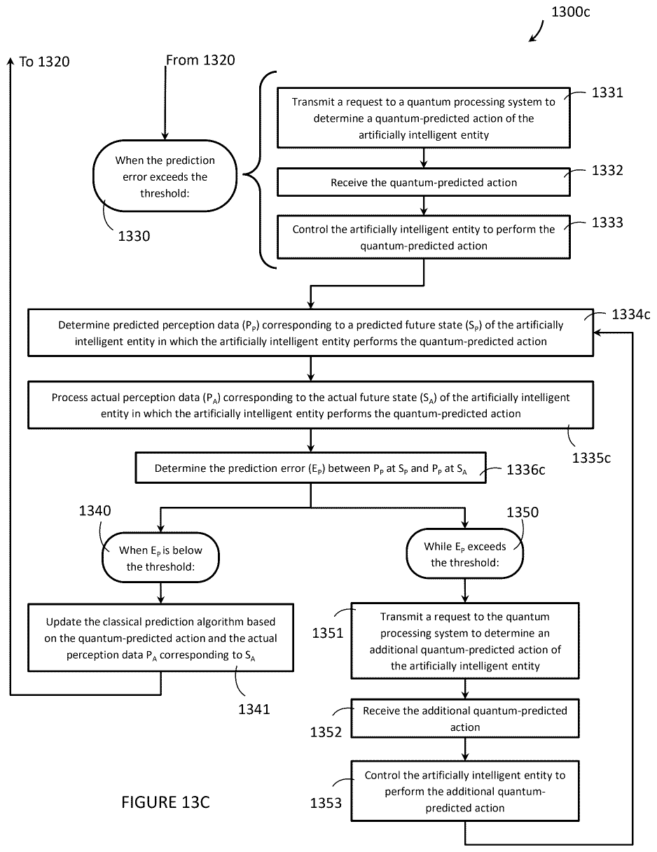

FIG. 13A is a flow diagram showing an exemplary computer-implemented method 1300 to control an artificially intelligent entity in accordance with the present systems, methods, and computer program products. As previously described, the artificially intelligent entity may include a physical embodiment (e.g., a robot) or a virtual embodiment such as an avatar or non-playable character in a virtual environment.

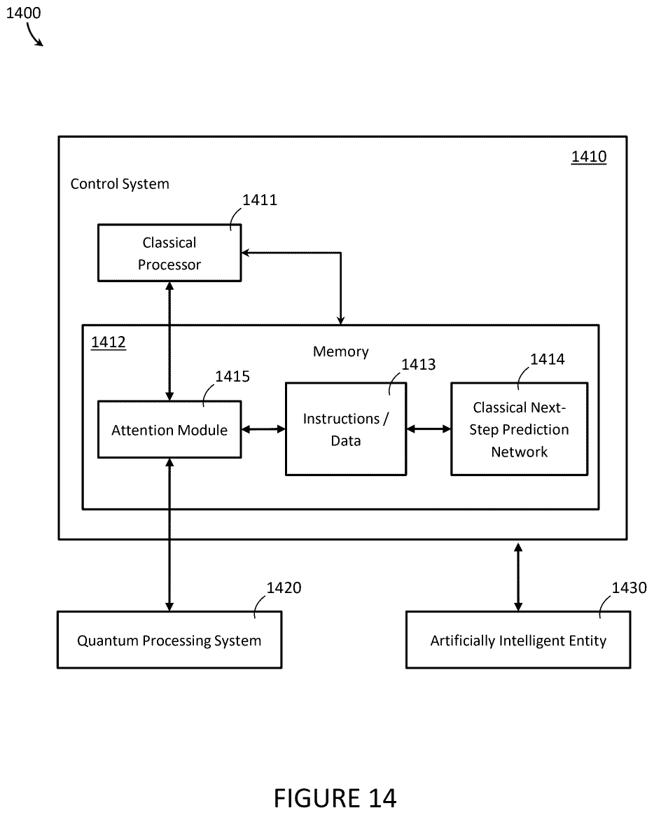

In general, throughout this specification and the appended claims, a computer-implemented method is a method in which at least some of the constituent acts are performed by one or more processor-based computer system(s), even if such acts are not explicitly described as being performed by one or more processor-based computer system(s). For example, certain acts of a computer-implemented method may be performed by at least one processor communicatively coupled to at least one non-transitory processor-readable storage medium or memory (hereinafter referred to as a non-transitory processor-readable storage medium) and, in some implementations, certain acts of a computer-implemented method may be performed by peripheral components of the computer system that are communicatively coupled to the at least one processor, such as interface devices, sensors, communications and networking hardware, and so on. The non-transitory processor-readable storage medium may store data and/or processor-executable instructions that, when executed by the at least one processor, cause the computer system to perform the method and/or cause the at least one processor to perform those acts of the method that are performed by the at least one processor. FIG. 14, and the written descriptions thereof, provide illustrative examples of computer systems that are suitable to perform the computer-implemented methods described herein.

Method 1300 includes one act 1301, two criteria or conditions 1320 and 1330, and eight conditional acts 1321, 1322, 1323, 1324, 1325, 1331, 1332, and 1333. Conditional acts 1321, 1322, 1323, 1324, and 1325 are conditional on condition 1320 and conditional acts 1331, 1332, and 1333 are conditional on condition 1330. Those of skill in the art will appreciate that in alternative implementations certain acts, conditions, and/or conditional acts may be omitted and/or additional acts, conditions, and/or conditional acts may be added. Those of skill in the art will also appreciate that the illustrated order of the acts, conditions, and/or conditional acts is shown for exemplary purposes only and may change in alternative implementations.

At 1301, perception data corresponding to a state of the artificially intelligent entity is/are processed, e.g., by a classical processor. As previously described, processing perception data corresponding to a state of an artificially intelligent entity may include processing sensor (real or virtual) data from one or more sensor(s) (real or virtual) on-board the artificially intelligent entity and/or processing other parameters representing properties of the artificially intelligent entity and/or its environment, all with a view towards characterizing the state of the artificially intelligent entity. Such processing may employ established techniques for digital signal processing, signal analysis, feature extraction, and other approaches to state characterization.

At a high-level, method 1300 involves: predicting future perception data that is expected (e.g., based on prior training data, an autonomous control policy, or similar) to be encountered when an artificially intelligent entity performs an action; controlling the artificially intelligent entity to perform the action; collecting the actual perception data realized when the artificially intelligent entity performs the action; and comparing the predicted perception data and the actual perception data to assess a quality of the prediction. The “quality of the prediction” is referred to herein as the “prediction error”. Thus, when the actual perception data realized is substantially similar to the predicted perception data (e.g., within a defined threshold, such as 1%, 5%, 10%, 20%, 30%, or more or less depending on the specific implementation), the prediction error is below the threshold and the quality of the prediction is high. Conversely, when the actual perception data realized is substantially different from the predicted perception data, the prediction error exceeds the threshold and the quality of the prediction is low. Method 1300 leverages classical processing to process perception data, determine predicted perception data, control actions, and determine prediction error, and leverages quantum processing when the classical-determined prediction error exceeds a threshold in order to improve the overall control system performance.

Returning to FIG. 13A, condition 1320 requires that the prediction error is below the defined threshold. As described above, the threshold may be specific to the particular implementation. In general, a tighter threshold (e.g., requiring that the actual perception data matches the predicted perception data to within a small percentage, such as within 0.5%, 1%, 5%, or similar) may impose stricter control parameters (e.g., tighter tolerances) on the artificially intelligent entity and a looser threshold (e.g., allowing the actual perception data to differ from the predicted perception data by a larger percentage, such as by 10%, 20%, or similar) may allow more freedom for the artificially intelligent entity. Either approach may be preferred depending on the specific application.

While condition 1320 is met (i.e., while the prediction error is below the threshold), conditional acts 1321, 1322, 1323, 1324, and 1325 are iteratively performed.

At 1321, a predicted action of the artificially intelligent entity is determined. In some implementations, the predicted action may be determined by a next-step prediction network invoked or executed by a classical processor of the control system.

At 1322, predicted perception data corresponding to a predicted future state of the artificially intelligent entity is determined. The predicted future state of the artificially intelligent entity may, for example, include the state of the artificially intelligent entity in which the artificially intelligent entity performs the predicted action determined at 1321. In some implementations, the next-step prediction network invoked or executed by the classical processor of the control system may determine the predicted perception data.

At 1323, the artificially intelligent entity is controlled to perform the predicted action determined at 1321. A person of skill in the art will appreciate that the technical details of how the artificially intelligent entity is controlled depend on the nature of the artificially intelligent entity itself (e.g., whether it is a real physical entity or a virtual entity). In the case of a virtual artificially intelligent entity (such as an avatar or non-playable character), controlling the entity to perform an action at 1323 may include executing (by the classical processor of the control system) instructions to cause the virtual entity (e.g., a display of the virtual entity) to move or perform in accordance with the intended action. In the case of a real physical artificially intelligent entity (such as a robot) that includes at least one sensor and at least one actuator, the perception data may include sensor data from the at least one sensor controlling the artificially intelligent entity to perform the predicted action may include defining control signals that, when received by the at least one actuator, cause the at least one actuator to perform the predicted action, and transmitting the control signals to the at least one actuator.

In some implementations, perception data may include data (e.g., motor data, encoder data, etc.) from the at least one actuator. Perception data from the at least one actuator may be obtained through several different modes/sensor types by at least one sensor coupled to the actuator, including without limitation current sensing by a current sensor, torque sensing by a torque sensor, temperature sensing by a temperature sensor, and/or motor error sensing.

At 1324, actual perception data corresponding to an actual future state of the artificially intelligent entity is/are collected and processed. The actual future state of the artificially intelligent entity may, for example, include the state of the artificially intelligent entity in which the artificially intelligent entity performs (at 1323) the predicted action determined at 1321. The actual perception data processed at 1324 may correspond to perception data collected during or after performance of the action determined at 1321 and performed at 1323.

At 1325, the prediction error between the predicted perception data (determined at 1322) and the actual perception data (processed at 1324) is determined, e.g., by the classical processor of the control system. If the prediction error determined at 1325 is below the threshold condition of 1320, then method 1300 returns to 1321 and repeats conditional acts 1321, 1322, 1323, 1324, and 1325 to continue classical control of the artificially intelligent entity. This iterative loop may be continued while the prediction error is and remains below the threshold defined at condition 1320. However, if/when the prediction error determined at (any iteration of) conditional act 1325 exceeds the threshold defined in condition 1320, condition 1320 is no longer satisfied. To accommodate this scenario, method 1300 includes condition 1330.

Condition 1330 requires that the prediction error exceeds the defined threshold. When the prediction error determined at any instance of act 1325 (i.e., in any iteration of conditional acts 1321, 1322, 1323, 1324, and 1325 carried out while condition 1320 is satisfied) exceeds the threshold, method 1300 stops iterating conditional acts 1321, 1322, 1323, 1324, and 1325 and instead proceeds to conditional acts 1331, 1332, and 1333.

At 1331, a request is transmitted by the control system (e.g., via a communicative coupling controlled by a communication interface component of the control system) to a quantum processing system. The request is for the quantum processing system to determine, by a quantum prediction algorithm such as a quantum next-step prediction network, a predicted action (i.e., a quantum-predicted action) of the artificially intelligent entity.

As previously described, various implementations of the present systems, methods, and computer program product may employ various forms of quantum processing hardware operative to perform various forms of quantum algorithms, including but not limited to quantum annealing algorithms and/or gate-model quantum algorithms. In an exemplary implementation, a quantum prediction network may include a quantum neural network that employs quantum mechanics principles, such as superposition and entanglement, to analyze data and forecast future outcomes. While classical neural networks use interconnected layers of artificial neurons to model complex data relationships, quantum neural networks employ qubits and (in gate-model implementations) quantum gates to enhance computational capacity. A person of skill in the art will appreciate that teachings for implementing quantum neural networks in prediction algorithms are extensive in the art, the details of which are leveraged by the present systems, methods, and computer program products. An illustrative example of quantum processing hardware operative to encode a quantum prediction network in a quantum annealing algorithm is provided in FIG. 5 and the descriptions thereof; however, as stated above other quantum processing hardware configurations and other encodings of quantum prediction networks may be employed to determine quantum-predicted states in accordance with the present systems, methods, and computer program products. In particular, while Hebbian learning techniques may be employed, other learning algorithms (including explicitly “non-Hebbian” learning techniques) may also be employed. For example, in some implementations the “J weights” providing coupling between qubits may be programmed or learned according to a wide range of different approaches that may include Hebbian, non-Hebbian, and other techniques.

In order to enable the quantum processing system to determine the quantum-predicted action, the request sent at 1331 may include information about the artificially intelligent entity and/or its environment and/or its context. For example, the request sent to the quantum processing systems by the control system at 1331 may include perception-action data, such as records of recent predicted/actual perception data and recent predicted/actual actions. Thus, in some implementations, the request sent at 1331 may request the quantum processing system to determine a quantum-predicted action based on current/recent perception data.

At 1332, the quantum-predicted action requested at 1331 is received from the quantum processing system by the control system.

At 1333, the control system controls the artificially intelligent entity to perform the quantum-predicted action. In accordance with the present systems, methods, and computer program products, the quantum-predicted action may differ from what the (classical) predicted action would be (e.g., at 1321) for given perception data, and due to the inherent computational advantages of quantum prediction networks over classical prediction networks, the quantum-predicted action may be advantageous over the (classical) predicted action.

At the completion of conditional act 1333, method 1300 may conclude or return to a state in which condition 1320 is deemed satisfied and therefore iteration of conditional acts 1321, 1322, 1323, 1324, and 1325 may resume.

As a specific example, the control system may leverage classical prediction networks to predict actions based on incoming perception data and control the artificially intelligent entity to perform those predicted actions (i.e., “on policy”, as it is known in the art) through multiple iterations while the prediction error remains below a threshold (i.e., while condition 1320 is satisfied). At some point, the classical prediction network may predict an action, and the system may control the artificially intelligent entity to perform an action, that produces new perception data that diverges from the predicted perception data corresponding to that action by an amount greater than a tolerable threshold. This corresponds to a scenario where the predicted (and performed) action is actually not a good fit for the perception data (i.e., not a good fit for the particular environment/context) and as such condition 1320 is no longer satisfied. Condition 1330 is satisfied instead. Since the current predicted action is deficient, the control system may formulate a request for the quantum processing system to provide an alternative, quantum-predicted action. The request formulation may include the most recent perception data and any other data/parameters necessary to structure the quantum prediction network to map between the artificially intelligent entity's perception and action spaces. In response, the quantum processing system may execute the quantum prediction network to determine a quantum-predicted action and transmit this quantum-predicted action to the control system. Because invoking the quantum processing system can be costly and more resource intensive then running an efficient classical control system, calls to the quantum processing system may be limited to such situations where the classical control system has failed to determine a suitable predicted action within the defined prediction error threshold. The quantum-predicted action provided by the quantum processing system may cure this deficiency, re-establishing a prediction error that is below the threshold, thus meeting condition 1320 of method 1300 and enabling the control system to return to running classical conditional acts 1321, 1322, 1323, 1324, and 1325.

In some implementations, the quantum-predicted action output by the quantum processing may be used to update/train the classical prediction network and improve its performance in future scenarios where similar perception data is/are encountered.

FIG. 13B is a flow diagram showing another exemplary computer-implemented method 1300b to control an artificially intelligent entity in accordance with the present systems, methods, and computer program products. Method 1300b includes all of the acts (1301), conditions (1320, 1330), and conditional acts (1321, 1322, 1323, 1324, 1325, 1331, 1332, 1333) of method 1300 plus three additional conditional acts 1334b, 1335b, and 1336b that also depend on condition 1330. In this way, method 1300b represents an extension of method 1300 to include additional conditional acts 1334b, 1335b, and 1336b. Those of skill in the art will appreciate that in alternative implementations certain acts, conditions, and/or conditional acts may be omitted and/or additional acts, conditions, and/or conditional acts may be added. Those of skill in the art will also appreciate that the illustrated order of the acts, conditions, and/or conditional acts is shown for exemplary purposes only and may change in alternative implementations.

Conditional act 1334b is performed when condition 1330 is satisfied. At 1334b, predicted perception data is classically determined by the control system (e.g., by executing or invoking the next-step prediction network), the predicted perception data corresponding to the predicted future state of the artificially intelligent entity in which the artificially intelligent entity performs the quantum-predicted action received at 1332. Conditional act 1334b may be performed before, after, or concurrently with conditional act 1333.

At 1335b, the control system processes actual perception data corresponding to the actual future state of the artificially intelligent entity in which the artificially intelligent entity performs the quantum-predicted action. That is, at 1334b the control system predicts the perception data that is likely to arise when the artificially intelligent entity performs the quantum-predicted action received at 1332; at 1333 the artificially intelligent entity performs the quantum-predicted action received at 1332; and at 1335b the control system processes the actual perception data collected when the artificially intelligent entity performs the quantum-predicted action received at 1332.

At 1336b, the control system updates the classical prediction algorithm (e.g., the classical next-step prediction network, or other classical prediction algorithm if another classical prediction algorithm is used) based on the quantum-predicted action performed at 1333 and the actual perception data processed at 1335b. The update applied at 1336b increases the likelihood that the classical prediction algorithm will return the quantum-predicted action (as a classically-predicted action) in future scenarios where similar perception data are predicted. In some implementations, the update applied at 1336b may include using a backpropagation style update to the weights in the various layers of the classical prediction network by calculating the error between the quantum-predicted action and the classically predicted action and using this to create error gradients that are propagated through the weights in the classical network.

At the completion of conditional act 1336b, method 1300b may conclude or return to a state in which condition 1320 is deemed satisfied and therefore iteration of conditional acts 1321, 1322, 1323, 1324, and 1325 may resume.

FIG. 13C is a flow diagram showing another exemplary computer-implemented method 1300c to control an artificially intelligent entity in accordance with the present systems, methods, and computer program products. Method 1300c represents an alternative extension of method 1300 that may be implemented instead of method 1300b. Thus, method 1300c includes all of the acts (1301), conditions (1320, 1330), and conditional acts (1321, 1322, 1323, 1324, 1325, 1331, 1332, 1333) of method 1300, and further includes additional conditional acts 1334c, 1335c, and 1336c all conditional on condition 1330, two new conditions 1340 and 1350, conditional acts 1341 and 1342 conditional on condition 1340, and conditional acts 1351, 1352, and 1353 conditional on condition 1350. Those of skill in the art will appreciate that in alternative implementations certain acts, conditions, and/or conditional acts may be omitted and/or additional acts, conditions, and/or conditional acts may be added. Those of skill in the art will also appreciate that the illustrated order of the acts, conditions, and/or conditional acts is shown for exemplary purposes only and may change in alternative implementations.

Conditional act 1334c is performed when condition 1330 is satisfied. At 1334c, predicted perception data (P_{P}) is classically determined by the control system (e.g., by executing or invoking the next-step prediction network), the predicted perception data P_{P} corresponding to the predicted future state (S_{P}) of the artificially intelligent entity in which the artificially intelligent entity performs the quantum-predicted action received at 1332. Conditional act 1334c may be performed before, after, or concurrently with conditional act 1333.

At 1335c, the control system processes actual perception data (P_{A}) corresponding to the actual future state (S_{A}) of the artificially intelligent entity in which the artificially intelligent entity performs the quantum-predicted action. That is, at 1334c the control system predicts the perception data P_{P} that is likely to arise when the artificially intelligent entity performs the quantum-predicted action received at 1332; at 1333 the artificially intelligent entity performs the quantum-predicted action received at 1332; and at 1335c the control system processes the actual perception data P_{A} collected when the artificially intelligent entity performs the quantum-predicted action received at 1332.

At 1336c, the control system determines the prediction error (E_{P}) between the predicted perception data P_{P} corresponding to the predicted future state S_{P} of the artificially intelligent entity in which the artificially intelligent entity performs the quantum-predicted action received at 1332 and the actual perception data P_{A} corresponding to the actual future state S_{A} of the artificially intelligent entity in which the artificially intelligent entity performs the quantum-predicted action received at 1332.

How method 1300c depends on the prediction error E_{P} determined at 1336c, as tested by conditions 1340 and 1350. Condition 1340 is satisfied when the prediction error E_{P} determined at 1336c is below the threshold (e.g., the same threshold used in conditions 1320 and 1330) and condition 1350 is satisfied when the prediction error E_{P} determined at 1336c exceeds the threshold.

When the prediction error E_{P} determined at 1336c is below the threshold, condition 1340 is satisfied the quantum-predicted action results in a reduced prediction error (e.g., compared to the classically-predicted action determined at 1321) and an overall improvement in the performance of the control system compared to what is achieved using classical processing alone. Thus, at 1341 the control system updates (e.g., similar to 1336b) the classical prediction algorithm (e.g., the classical next-step prediction network if used) based on the quantum-predicted action and the actual perception data P_{A} corresponding to the actual future state S_{A} of the artificially intelligent entity in which the artificially intelligent entity performs the quantum-predicted action.

When and while the prediction error E_{P} determined at 1336c exceeds the threshold, condition 1350 is satisfied and the quantum prediction algorithm is not sufficiently outperforming the classical prediction algorithm. Method 1300c thus does not proceed to update the classical prediction algorithm at 1341 but instead seeks (through conditional acts 1351, 1352, and 1353) an additional quantum-predicted action that sufficiently reduces the prediction error E_{P}.

At 1351, the control system transmits a request (e.g., through a communication interface that couples between the control system and the quantum processing system) to the quantum processing system to determine an additional quantum-predicted action of the artificially intelligent entity, e.g., based on perception data such as that processed at 1335c. In response to the request, the quantum processing system runs a quantum prediction algorithm (such as a quantum prediction network in the form of a quantum neural network) to determine the additional quantum-predicted action.

At 1352, the control system receives (e.g., through the same communication interface used in 1351) the additional quantum-predicted action from the quantum processing system.

At 1353, the control system controls the artificially intelligent entity to perform the additional quantum-predicted action received at 1352. From conditional act 1353, method 1300c returns to 1334c and re-performs 1334 c, 1335 c, and 1336 c using the additional quantum-predicted action received at 1352. This results in an additional prediction error E_{P} determined at 1336c for the additional quantum-predicted action received at 1352. When and while the additional prediction error E_{P} continues to exceed the threshold, condition 1350 remains satisfied and method 1300c continues to iterate in the “quantum action prediction loop” represented by conditional acts 1334c, 1335c, 1336c, 1351, 1352, and 1353. When the additional prediction error E_{P} falls below the threshold, condition 1340 is met and method 1300c updates the classical prediction algorithm at 1351 and then returns to running classical action predictions through conditional acts 1321, 1322, 1323, 1324, and 1325 while condition 1320 remains met.

In the various implementations of methods 1300, 1300b, and 1300c described above, conditions are often defined by whether a prediction error is below or exceeds a threshold. In some scenarios, the prediction error may equal the threshold. A person of skill in the art will appreciate that the specific scenario of the prediction error E_{P} being equal to the threshold may be included in conditions where the prediction error is below the threshold (as “equal to or below the threshold”) or in conditions where the prediction error exceeds the threshold (as “equal to or exceeds the threshold”) depending on the specific implementation and, in particular, depending on the definition of the threshold. Thus, a person of skill in the art will appreciate that when bifurcating conditions are employed (as in conditions 1320/1330 and 1340/1350), the scenario where the prediction error is equal to the threshold may arbitrarily, or deliberately, be encompassed in one of the bifurcating conditions.

Throughout the descriptions of methods 1300, 1300b, and 1300c, reference is frequently made to a control system. FIG. 14 is a schematic diagram of an illustrative example of a hybrid classical-quantum architecture 1400 that may implement the various methods and computer program products described herein, including but not limited to methods 1300, 1300b, and 1300c, in order to control an artificially intelligent entity.

Hybrid classical-quantum architecture 1400 includes classical control system 1410 that is communicatively coupled (e.g., via one or more communication interfaces, not shown) to both at least one quantum processing system 1420 and an artificially intelligent entity 1430. Classical control system 1410 includes at least one classical processor 1411 communicatively coupled to at least one non-transitory processor-readable storage medium or “memory” 1412. Memory 1412 stores processor-executable instructions and/or data 1413 that, when executed by the at least one classical processor 1411, cause control system 1410 to perform the various acts and conditional acts performed by the control system in methods 1300, 1300b, and/or 1300c. To that end, memory 1412 also stores a classical next-step prediction network (or other classical prediction algorithm) that may be executed or invoked by control system 1410 to predict perception data and/or actions of the artificially intelligent entity 1430, e.g., as described in methods 1300, 1300b, and 1300c.

In the illustrated implementation of FIG. 14, memory 1412 of control system 1410 includes an attention module 1415 to monitor prediction errors (e.g., as determined at conditional acts 1325 and/or 1336c) and control communication with the at least one quantum processing system 1420 based on the prediction error. In other words, attention module 1415 may receive requests for predicted actions and route such requests to either classical processor 1411 (running classical next-step prediction network 1414) or quantum processing system 1420 (running a quantum prediction network) depending on the state of the prediction error (e.g., depending on whether condition 1320 or 1330 is satisfied, or depending on whether condition 1340 or 1350 is satisfied). In accordance with the present systems, methods, and computer program products, attention module 1415 may operate in real-time to facilitate switching between the classical prediction algorithm and the quantum prediction algorithm during active control of and activity by the artificially intelligent entity. Indeed, methods 1300, 1300b, and 1300c may all be run in real-time to achieve hybrid classical-quantum control of an artificially intelligent entity and as-it-happens updates/improvements to the classical prediction algorithm.

In the illustrated implementation of FIG. 14, control system 1410 is shown remote from artificially intelligent entity 1430 with communicative coupling therebetween (e.g., via a communication interface, not shown to reduce clutter). However, in alternative implementations, some or all of classical control system 1410 may be carried locally on-board artificially intelligent entity 1430. Such implementations may be particularly advantageous when artificially intelligent entity 1430 is or includes a mobile robot, where an on-board version of control system 1410 may allow autonomous operation through predictive classical control with access to remote quantum action prediction when necessary to support and further develop autonomy.

In some implementations, memory 1412 from classical control system 1411 may be packaged and distributed as a computer program product that, when: i) memory 1412 is communicatively coupled to at least one classical processor of a control system that is communicatively coupled to both a quantum computing system and an artificially intelligent entity, and ii) the processor-executable instructions and/or data 1413 of memory 1412 are executed by the at least one classical processor of the control system, the processor-executable instructions and/or data 1413 cause the control system to perform any or all of methods 1300, 1300b, and/or 1300c.

The various implementations described herein improve the functioning of computer systems for the specific practical application of (autonomous) control of artificially intelligent entities. The present systems, methods, and computer program products invoke a quantum processing system running a quantum predictive algorithm to enhance and even train an otherwise classical predictive control process, which can achieve better overall autonomous performance in the artificially intelligent entity, or at least comparable performance more efficiently by requiring less training data and/or fewer training cycles. While attempting to run an autonomous control system exclusively using quantum predictive networks would be costly and unwieldy, the present systems, methods, and computer program products describe an innovative hybrid control architecture that isolates situations (e.g., when prediction error is unacceptably high) where quantum predictive networks can be utilized to their greatest advantage and leverages their ability to outperform classical predictive networks in such isolated situations. The specialized architecture is specifically well-suited to perform the algorithms of methods 1300, 1300b, and 1300c and, in some implementations, may even include dedicated structures or modules, such as attention module 1415, that are specifically employed in the execution of such methods. Indeed, methods 1300, 1300b, and 1300c cannot be executed by conventional generic classical computing systems or by quantum processing systems on their own-they require the specialized integrated architectures described herein, such as hybrid classical-quantum architecture 1400.

Throughout this specification and the appended claims the term “communicative” as in “communicative coupling” and in variants such as “communicatively coupled,” is generally used to refer to any engineered arrangement for transferring and/or exchanging information. For example, a communicative coupling may be achieved through a variety of different media and/or forms of communicative pathways, including without limitation: electrically conductive pathways (e.g., electrically conductive wires, electrically conductive traces), magnetic pathways (e.g., magnetic media), wireless signal transfer (e.g., radio frequency antennae), and/or optical pathways (e.g., optical fiber). Exemplary communicative couplings include, but are not limited to: electrical couplings, magnetic couplings, radio frequency couplings, and/or optical couplings.

Throughout this specification and the appended claims, infinitive verb forms are often used. Examples include, without limitation: “to encode,” “to provide,” “to store,” and the like. Unless the specific context requires otherwise, such infinitive verb forms are used in an open, inclusive sense, that is as “to, at least, encode,” “to, at least, provide,” “to, at least, store,” and so on.

All publications, patents and patent applications mentioned in this specification are indicative of the level of skill of those skilled in the art to which the present systems, methods, and computer program products pertain and are herein incorporated by reference. The reference to any prior art in this specification is not, and should not be taken as, an acknowledgement or any form of suggestion that such prior art forms part of the common general knowledge.

This specification, including the drawings and the abstract, is not intended to be an exhaustive or limiting description of all implementations and embodiments of the present systems, methods, and computer program products. A person of skill in the art will appreciate that the various descriptions and drawings provided may be modified without departing from the spirit and scope of the disclosure. In particular, the teachings herein are not intended to be limited by or to the illustrative examples of computer systems and computing environments provided.

This specification provides various implementations and embodiments in the form of block diagrams, schematics, flowcharts, and examples. A person skilled in the art will understand that any function and/or operation within such block diagrams, schematics, flowcharts, or examples can be implemented, individually and/or collectively, by a wide range of hardware, software, and/or firmware. For example, the various embodiments disclosed herein, in whole or in part, can be equivalently implemented in one or more: application-specific integrated circuit(s) (i.e., ASICs); standard integrated circuit(s); computer program(s) executed by any number of computers (e.g., program(s) running on any number of computer systems); program(s) executed by any number of controllers (e.g., microcontrollers); and/or program(s) executed by any number of processors (e.g., microprocessors, central processing units, graphical processing units), as well as in firmware, and in any combination of the foregoing.

Throughout this specification and the appended claims, a “memory” or “storage medium” is a processor-readable medium that is an electronic, magnetic, optical, electromagnetic, infrared, semiconductor, or other physical device or means that contains or stores processor data, data objects, logic, instructions, and/or programs. When data, data objects, logic, instructions, and/or programs are implemented as software and stored in a memory or storage medium, such can be stored in any suitable processor-readable medium for use by any suitable processor-related instruction execution system, apparatus, or device, such as a computer-based system, processor-containing system, or other system that can fetch the data, data objects, logic, instructions, and/or programs from the memory or storage medium and perform various acts or manipulations (i.e., processing steps) thereon and/or in response thereto. Thus, a “non-transitory processor-readable storage medium” can be any element that stores the data, data objects, logic, instructions, and/or programs for use by or in connection with the instruction execution system, apparatus, and/or device. As specific non-limiting examples, the processor-readable medium can be: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and/or any other non-transitory medium.

The claims of the disclosure are below. This disclosure is intended to support, enable, and illustrate the claims but is not intended to limit the scope of the claims to any specific implementations or embodiments. In general, the claims should be construed to include all possible implementations and embodiments along with the full scope of equivalents to which such claims are entitled.

1. A control system for an artificially intelligent entity, the control system comprising:
at least one classical processor;
a communication interface communicatively coupled to the at least one classical processor and to at least one quantum processing system; and
at least one non-transitory processor-readable storage medium communicatively coupled to the at least one classical processor, the at least one non-transitory processor-readable storage medium storing a classical next-step prediction network and processor-executable instructions and/or data that, when executed by the at least one classical processor, cause the control system to:
process perception data corresponding to a state of the artificially intelligent entity;
while a prediction error is below a threshold, iteratively:
determine, by the classical next-step prediction network, a predicted action of the artificially intelligent entity;
determine, by the classical next-step prediction network, predicted perception data corresponding to a predicted future state of the artificially intelligent entity;
control the artificially intelligent entity to perform the predicted action;
process actual perception data corresponding to an actual future state of the artificially intelligent entity;
determine the prediction error between the predicted perception data and the actual perception data;
when the prediction error exceeds the threshold:
transmit, by the communication interface, a request to the at least one quantum processing system to determine, by a quantum next-step prediction algorithm, a quantum-predicted action of the artificially intelligent entity;
receive, by the communication interface, the quantum-predicted action; and
control the artificially intelligent entity to perform the quantum-predicted action.

2. The control system of claim 1 wherein the at least one non-transitory processor-readable storage medium further stores an attention module to monitor the prediction error and control communication with the at least one quantum processing system based on the prediction error.

3. The control system of claim 1 wherein the artificially intelligent entity is selected from a group consisting of: a physical embodiment, a robot, a virtual avatar, and a non-playable character in a virtual environment.

4. The control system of claim 1 wherein the artificially intelligent entity includes a physical embodiment with a least one sensor, and wherein the perception data includes sensor data from the at least one sensor.

5. The control system of claim 4 wherein the control system is carried on-board the physical embodiment.

6. The control system of claim 4 wherein the control system is remote from the physical embodiment, and wherein the communication interface is communicatively coupled to the physical embodiment.

7. The control system of claim 4 wherein the physical embodiment includes at least one actuator, and wherein the processor-executable instructions and/or data that, when executed by the at least one classical processor, cause the control system to control the artificially intelligent entity to perform the predicted action, cause the control system to define and transmit control signals to the at least one actuator.

8. The control system of claim 7 wherein the perception data includes data from at least one sensor coupled to the at least one actuator.

9. The control system of claim 1 wherein the processor-executable instructions and/or data, when executed by the at least one classical processor, further cause the control system to:
determine, by the classical next-step prediction network, predicted perception data corresponding to a predicted future state of the artificially intelligent entity in which the artificially intelligent entity performs the quantum-predicted action;
process actual perception data corresponding to the actual future state of the artificially intelligent entity in which the artificially intelligent entity performs the quantum-predicted action; and
update the classical next-step prediction network based on the quantum-predicted action and the actual perception data corresponding to the actual future state of the artificially intelligent entity in which the artificially intelligent entity performs the quantum-predicted action.

10. The control system of claim 1 wherein the processor-executable instructions and/or data, when executed by the at least one classical processor, further cause the control system to:
when the prediction error exceeds the threshold:
determine, by the classical next-step prediction network, predicted perception data corresponding to a predicted future state of the artificially intelligent entity in which the artificially intelligent entity performs the quantum-predicted action;
process actual perception data corresponding to the actual future state of the artificially intelligent entity in which the artificially intelligent entity performs the quantum-predicted action;
determine the prediction error between the predicted perception data corresponding to the predicted future state of the artificially intelligent entity in which the artificially intelligent entity performs the quantum-predicted action and the actual perception data corresponding to the actual future state of the artificially intelligent entity in which the artificially intelligent entity performs the quantum-predicted action;
if the prediction error between the predicted perception data corresponding to the predicted future state of the artificially intelligent entity in which the artificially intelligent entity performs the quantum-predicted action and the actual perception data corresponding to the actual future state of the artificially intelligent entity in which the artificially intelligent entity performs the quantum-predicted action is below the threshold:
update the classical next-step prediction network based on the quantum-predicted action and the actual perception data corresponding to the actual future state of the artificially intelligent entity in which the artificially intelligent entity performs the quantum-predicted action; and
if the prediction error between the predicted perception data corresponding to the predicted future state of the artificially intelligent entity in which the artificially intelligent entity performs the quantum-predicted action and the actual perception data corresponding to the actual future state of the artificially intelligent entity in which the artificially intelligent entity performs the quantum-predicted action exceeds the threshold:
transmit, by the communication interface, a request to the at least one quantum processing system to determine, by the quantum next-step prediction algorithm, an additional quantum-predicted action of the artificially intelligent entity;
receive, by the communication interface, the additional quantum-predicted action; and
control the artificially intelligent entity to perform the additional quantum-predicted action.

11. A computer-implemented method to control an artificially intelligent entity, the method comprising:
processing perception data corresponding to a state of the artificially intelligent entity;
while a prediction error is below a threshold, iteratively:
determining a predicted action of the artificially intelligent entity;
determining predicted perception data corresponding to a predicted future state of the artificially intelligent entity;
controlling the artificially intelligent entity to perform the predicted action;
processing actual perception data corresponding to an actual future state of the artificially intelligent entity;
determining the prediction error between the predicted perception data and the actual perception data;
when the prediction error exceeds the threshold:
transmitting a request to a quantum processing system to determine a quantum-predicted action of the artificially intelligent entity;
receiving the quantum-predicted action; and
controlling the artificially intelligent entity to perform the quantum-predicted action.

12. The computer-implemented method of claim 11 wherein:
determining the predicted action of the artificially intelligent entity includes determining, by a classical next-step prediction network, the predicted action of the artificially intelligent entity; and
determining predicted perception data corresponding to a predicted future state of the artificially intelligent entity includes determining, by the classical next-step prediction network, predicted perception data corresponding to a predicted future state of the artificially intelligent entity.

13. The computer-implemented method of claim 12, further comprising:
determining, by the classical next-step prediction network, predicted perception data corresponding to a predicted future state of the artificially intelligent entity in which the artificially intelligent entity performs the quantum-predicted action;
processing actual perception data corresponding to the actual future state of the artificially intelligent entity in which the artificially intelligent entity performs the quantum-predicted action; and
updating the classical next-step prediction network based on the quantum-predicted action and the actual perception data corresponding to the actual future state of the artificially intelligent entity in which the artificially intelligent entity performs the quantum-predicted action.

14. The computer-implemented method of claim 12, further comprising:
when the prediction error exceeds the threshold:
determining, by the classical next-step prediction network, predicted perception data corresponding to a predicted future state of the artificially intelligent entity in which the artificially intelligent entity performs the quantum-predicted action;
processing actual perception data corresponding to the actual future state of the artificially intelligent entity in which the artificially intelligent entity performs the quantum-predicted action;
determining the prediction error between the predicted perception data corresponding to the predicted future state of the artificially intelligent entity in which the artificially intelligent entity performs the quantum-predicted action and the actual perception data corresponding to the actual future state of the artificially intelligent entity in which the artificially intelligent entity performs the quantum-predicted action;
when the prediction error between the predicted perception data corresponding to the predicted future state of the artificially intelligent entity in which the artificially intelligent entity performs the quantum-predicted action and the actual perception data corresponding to the actual future state of the artificially intelligent entity in which the artificially intelligent entity performs the quantum-predicted action is below the threshold:
updating the classical next-step prediction network based on the quantum-predicted action and the actual perception data corresponding to the actual future state of the artificially intelligent entity in which the artificially intelligent entity performs the quantum-predicted action;
and
while the prediction error between the predicted perception data corresponding to the predicted future state of the artificially intelligent entity in which the artificially intelligent entity performs the quantum-predicted action and the actual perception data corresponding to the actual future state of the artificially intelligent entity in which the artificially intelligent entity performs the quantum-predicted action exceeds the threshold:
transmitting a request to the quantum processing system to determine an additional quantum-predicted action of the artificially intelligent entity;
receiving the additional quantum-predicted action; and
controlling the artificially intelligent entity to perform the additional quantum-predicted action.

15. The computer-implemented method of claim 11 wherein the artificially intelligent entity is selected from a group consisting of: a physical embodiment, a robot, a virtual avatar, and a non-playable character in a virtual environment.

16. The computer-implemented method of claim 15 wherein:
the artificially intelligent entity includes a physical embodiment with at least one sensor and at least one actuator;
the perception data includes sensor data from the at least one sensor; and
controlling the artificially intelligent entity to perform the predicted action includes:
defining control signals that, when received by the at least one actuator, cause the at least one actuator to perform the predicted action; and
transmitting the control signals to the at least one actuator.

17. A computer program product comprising a non-transitory processor-readable storage medium storing a classical next-step prediction network and processor-executable instructions and/or data, wherein when: i) the non-transitory processor-readable storage medium is communicatively coupled to at least one classical processor of a control system that is communicatively coupled to both a quantum computing system and an artificially intelligent entity, and ii) the processor-executable instructions and/or data are executed by the at least one classical processor of the control system, the processor-executable instructions and/or data cause the control system to:
process perception data corresponding to a state of the artificially intelligent entity;
while a prediction error is below a threshold, iteratively:
determine, by the classical next-step prediction network, a predicted action of the artificially intelligent entity;
determine, by the classical next-step prediction network, predicted perception data corresponding to a predicted future state of the artificially intelligent entity;
control the artificially intelligent entity to perform the predicted action;
process actual perception data corresponding to an actual future state of the artificially intelligent entity;
determine the prediction error between the predicted perception data and the actual perception data;
when the prediction error exceeds the threshold:
transmit a request to the quantum processing system to determine, by a quantum next-step prediction algorithm, a quantum-predicted action of the artificially intelligent entity;
receive the quantum-predicted action; and
control the artificially intelligent entity to perform the quantum-predicted action.

18. The computer program product of claim 17 wherein the artificially intelligent entity includes a physical embodiment, and wherein the computer program product is carried on-board the physical embodiment.

19. The computer program product of claim 17 wherein the processor-executable instructions and/or data, when executed by the at least one classical processor of the control system, further cause the control system to:
determine, by the classical next-step prediction network, predicted perception data corresponding to a predicted future state of the artificially intelligent entity in which the artificially intelligent entity performs the quantum-predicted action;
process actual perception data corresponding to the actual future state of the artificially intelligent entity in which the artificially intelligent entity performs the quantum-predicted action; and
update the classical next-step prediction network based on the quantum-predicted action and the actual perception data corresponding to the actual future state of the artificially intelligent entity in which the artificially intelligent entity performs the quantum-predicted action.

20. The computer program product of claim 17 wherein the processor-executable instructions and/or data, when executed by the at least one classical processor of the control system, further cause the control system to:
when the prediction error exceeds the threshold:
determine, by the classical next-step prediction network, predicted perception data corresponding to a predicted future state of the artificially intelligent entity in which the artificially intelligent entity performs the quantum-predicted action;
process actual perception data corresponding to the actual future state of the artificially intelligent entity in which the artificially intelligent entity performs the quantum-predicted action;
determine the prediction error between the predicted perception data corresponding to the predicted future state of the artificially intelligent entity in which the artificially intelligent entity performs the quantum-predicted action and the actual perception data corresponding to the actual future state of the artificially intelligent entity in which the artificially intelligent entity performs the quantum-predicted action;
when the prediction error between the predicted perception data corresponding to the predicted future state of the artificially intelligent entity in which the artificially intelligent entity performs the quantum-predicted action and the actual perception data corresponding to the actual future state of the artificially intelligent entity in which the artificially intelligent entity performs the quantum-predicted action is below the threshold:
update the classical next-step prediction network based on the quantum-predicted action and the actual perception data corresponding to the actual future state of the artificially intelligent entity in which the artificially intelligent entity performs the quantum-predicted action; and
while the prediction error between the predicted perception data corresponding to the predicted future state of the artificially intelligent entity in which the artificially intelligent entity performs the quantum-predicted action and the actual perception data corresponding to the actual future state of the artificially intelligent entity in which the artificially intelligent entity performs the quantum-predicted action exceeds the threshold:
transmit a request to the quantum processing system to determine an additional quantum-predicted action of the artificially intelligent entity;
receive the additional quantum-predicted action; and
control the artificially intelligent entity to perform the additional quantum-predicted action.
